(19) United States
(12) Patent Application Publication
(10) Pub. No.: US 2005/0204337 A1
(43) Pub. Date: Sep. 15, 2005

(54) System for developing an electronic presentation

(75) Inventors: Michael E. Diesel, Saugus, MA (US); Peter J. Isermann, Rossville, KS (US); Richard T. Beck IV, Rossville, KS (US); Jeffrey L. Knight, St. Marys, KS (US); Shane W. Hill, St. Marys, KS (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Automatic E-Learning LLC, St. Marys, KS (US)

(21) Appl. No.: 11/028,466

(22) Filed: Jan. 3, 2005

Related U.S. Application Data
(60) Provisional application No. 60/533,698, filed on Dec. 31, 2003.

(51) Int. Cl. G06F 9/44

(52) U.S. Cl. 717/113; 717/109; 717/162

(57) ABSTRACT

A highly portable user-friendly development environment is provided that can enable the creative design of custom electronic presentations. Users can design their own custom presentations and even their own custom approach for making software development a rational industrial process. The document-based authoring environment uses a standard word processing document, which is controlled by a wizard. The development of presentations can take place in the cells of an electronic table of the word processing document. This document-based authoring environment can expand the possibilities of e-learning course development beyond conventional database development environments.

### RELATED APPLICATIONS

This application claims the benefit of U.S. Patent Application No. 60/533,698 filed Dec. 31, 2003, and discloses subject matter also disclosed in U.S. patent application Ser. No. 10/287,441 filed Nov. 1, 2002, U.S. Provisional Patent Application No. 60/494,760 filed Aug. 12, 2003 U.S. Provisional Patent Application No. 60/530,457 filed Dec. 17, 2003, and in U.S. Patent Application No.:______ filed on even date with this application (attorney docket number 3324.1002-002), entitled “System and Method for Implementing an Electronic Presentation,” the entire teachings of which are incorporated herein by reference.

### BACKGROUND

There are a number of ways to create a computerized learning environment. Traditionally, a simulated learning environment is developed using educational audio and visual content. In the typical scenario, a combination of text, audio, video and animated content are arranged into a presentation and stored in electronic format. This arrangement of content creates a simulated learning environment that is often referred to as electronic learning (e-learning).

Conventional e-learning courses have been developed using media management systems, such as database systems. This backend database component has been extremely important in enabling the course developer to organize its content for an e-learning course. However, developing e-learning courses in connection with databases requires a high level of expertise. For example, if the database is a relational database one must be able to define certain levels of relationships, such as one-to-many relationships, many-to-many or many-to-one relationships. In general, most multimedia development environments are not very user-friendly and they require an experienced developer, thus effectively blocking the subject matter expert from accessing the course development materials.

Thus, one of the biggest challenges in developing e-learning courses that are tailored to a particular industry or corporation's needs is that, in general, it requires highly-trained developers to develop the software product, which can be cost-prohibitive. Moreover, because such developers are often poorly versed in the needs and demands of a particular industry or corporation, the final course often does not effectively satisfy the needs or demands of the corporation. As a result, a company, for example, may request a series of course updates to incorporate certain features or particular content that was overlooked by the developers during the development phase. Frequent updates can cost the company dearly. Ideally, the company's personnel could create their own software systems so that the company could effectively tailor their system to meet its needs. In general, however, the average company employee does not possess the software development skills to create or update such a system. Therefore, it is typically not possible for a company to have its normal employees design their e-learning systems.

Content users want user-friendly interactive presentations with rich media. Meanwhile, developers and companies want a development environment that is easily implemented and enables them to effectively deploy content and without encumbering the content users. Thus, one of the most complicated aspects of developing a content development and deployment system is finding a scheme in which the cost benefit analysis accommodates all participants. At this time, the currently available schemes do not provide a user-friendly, developer-friendly and financially effective solution to develop multimedia content.

### SUMMARY

The present system provides a highly-portable user-friendly development environment that can enable the creative design of custom software products, such as browser-based courses. Users can design their own custom software and even their own custom approach for making software development a rational industrial process. The present invention can expand the possibilities of e-learning course development beyond conventional database development environments. With the present invention, the development of presentations can take place in the cells of an electronic table of a word processing document.

Because the authoring environment is primarily document based, it provides an extremely flexible storyboard-based authoring environment that is highly desirable for instructional designers that work with subject matter experts in disparate locations. For example, data exchange is enabled via email, FTP, File Servers and Microsoft Word applications. Changes made to content in the storyboard are easily reviewed by using standard authoring tools, such as the track changes feature of Microsoft Word. Unlike other industry storyboarding processes, however, the preferred authoring environment builds a course directly from data stored in the document itself, without the course designer having to be on the network and access a complex authoring system with a database containing the structure of the course or in order to (again) post the data to pre-defined screens and templates.

According to an embodiment, a computerized system for controlling a development environment using a word processing document is provided. A standard word processing document is controlled using a wizard. The word processing document includes an electronic table. The table has at least two states. The state of the table defines an operating mode for the wizard.

The state of the table can be associated with a media development context. The media development context can be a storyboard, lesson, or interactive exercise or assessment question. The table, wizard and word processing document can provide an document-based authoring environment. The wizard can be in communication with a builder engine. The builder engine can be responsible for generating data, based on the state of the table. The data may be stored in XML format. The builder can generate data that is associated with an electronic presentation. The electronic presentation may be related to e-learning. The state of the table can be based on constructs identified in the table or in the heading that prefaces the table. The builder is responsive to the constructs. An object reference can be associated with the processing document. The object reference can be used by the wizard to send commands to the word processing document. The wizard can control the word processing document using object linking and embedded technology. The word processing document can be, for example, a Microsoft Word document.

The wizard can position its own window and the word processing window on the screen so that they don't overlap and can be used together. The developer can modify the word processing document directly, without a making the changes to the document in a separate window. The wizard can control the word processing document without changing operating environments. The state of the table can define an operating mode of the wizard, such as a storyboard mode, media page mode, lesson mode, or interactive exercise or assessment mode.

The wizard can respond to user interaction by controlling the word processing document. The wizard can respond to user interaction by monitoring interaction with a timer event. The timer event causes the wizard to check the word processing document. The timer event can cause the wizard to check the word processing document at regular intervals. The timer event can be fired at regular intervals. The wizard can respond to the event by detecting any changes in user interaction with the word processing document.

The wizard can assign an identifier to the table. The identifier corresponds to the state of the table. The identifier changes when the state of the table changes. The wizard toggles between operating modes in response to an identifier change.

### BRIEF DESCRIPTION OF THE DRAWINGS

The foregoing and other objects, features and advantages of the invention will be apparent from the following more particular description of the Computerized Learning System, as illustrated in the accompanying drawings in which like reference characters refer to the same parts throughout the different views. For clarity and ease of description, the drawings are not necessarily to scale, emphasis instead being placed upon illustrating the principles of the invention.

FIG. 1 is a block diagram of network systems architecture in accordance with the an online embodiment of the invention.

FIG. 2 is a block diagram illustrating media components of an interactive presentation according to an embodiment of the invention.

FIG. 3 is a diagram illustrating an interactive presentation displayed in a browser user interface.

FIG. 4 is a diagram illustrating a table of contents of the user interface.

FIG. 5 is a block diagram illustrating the system architecture for creating an interactive presentation using a database authoring environment.

FIG. 6 is a block diagram illustrating an embodiment of the database authoring environment of FIG. 5.

FIG. 7 is a flow diagram describing the steps of the CME application.

FIG. 8 is a diagram illustrating the interface of the CME application.

FIG. 9 is a diagram illustrating the template manager interface of the CME application.

FIG. 10 is a diagram illustrating the time-coder interface of the CME application

FIG. 11 is a block diagram illustrating system architecture for creating an interactive presentation according to an embodiment of the invention.

FIG. 12 is block diagram illustrating an embodiment of the XML player.

FIG. 13 is a flow diagram describing the steps of the document-based authoring system of FIG. 11.

FIG. 14 is a block diagram illustrating an embodiment of FIG. 11.

FIG. 15 is a diagram illustrating a table for a dichotomous exercise or assessment.

FIG. 16 is a diagram illustrating the table data of FIG. 15 in a dichotomous interactive exercise displayed on the animation-video region of the user interface.

FIG. 17A is a diagram illustrating the document-based authoring environment for creating an interactive presentation using a table wizard according to an embodiment of the invention.

FIG. 17B is a diagram illustrating the selection of a row in the storyboard table according to an embodiment of FIG. 17A.

FIG. 17C is a diagram illustrating the page specified in the media table of FIG. 17A.

FIG. 17D is a diagram illustrating the storyboard specified in the storyboard table of FIG. 17A.

FIG. 17E is a block diagram of the table wizard using a timer process to control and manage the state of a word processing document.

FIG. 18A is a diagram of a course pretest page illustrating the situation where a the pretest score changes the course path.

FIG. 18B is a dialog box indicating that a particular lesson may be skipped.

FIG. 18C is a flow diagram of the process of including pretest question(s) within a lesson at development time.

FIG. 18D is a diagram of a course entry page illustrating multiple entry points in a course.

FIG. 19A is a diagram of a page in an introductory course in a daughter window that is linked from a page in an advanced course. FIG. 19B is a diagram of a search process is provided that enables the user to search for a particular term.

FIGS. 19C is a diagram of the glossary providing different levels of explanation of a term.

FIG. 19D is a flow diagram describing the process for identifying reusable content according to an embodiment of the invention.

### DETAILED DESCRIPTION

A number of different participants may be involved in developing, deploying and using an interactive presentation. For purposes of illustration, the interactive presentation can be an e-learning course. A subject matter expert (developer) may be involved in the development of the e-learning course. The subject matter expert is an expert on the content of the course. Usually, the subject matter expert is not a course teacher, and does not understand instructional design principals. A graphic artist (developer) may be involved that can work with multimedia software packages, such as Flash. The graphic artist may have animation skills. An instructional designer (developer) may also be involved. The instructional design may be trained in the how to construct education and in the use of authoring tools. Learners or students (users), who are the users of the interactive presentation (e.g. courses), may also be involved. Further, an administrator may be involved. The administrator may be equivalent to a network administrator. The administrator may install new content (e.g. new releases, new presentations, new courses). A group manager may also be involved. The group manager manages the e-Learning needs of a group of people. The group manager can add new users to the learning server and can add new courses. The group manager can also enroll students in courses and monitor their progress. It is important to note that an individual can perform any combination of these roles.

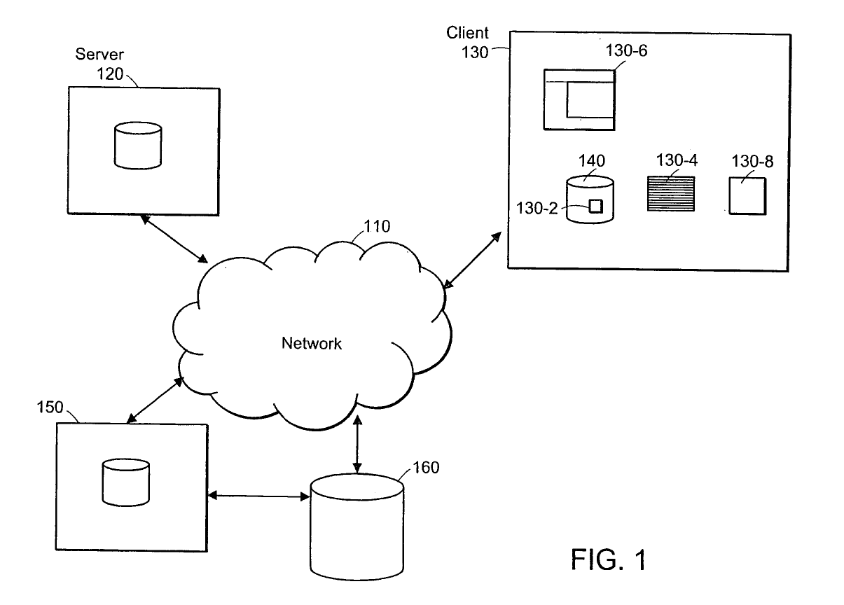

An interactive presentation may be deployed over a network or deployed from an offline device. For purposes of illustration, an online configuration will be discussed. For instance, FIG. 1 is a block diagram of network systems architecture in accordance with an online embodiment of the invention. An interactive presentation is distributed over a network 110. The interactive presentation enables management of both hardware and software components over the network 110 using Internet technology. The network 110 includes at least one server 120, and at least one client system 130. The client system 130 can connect to the network 110 with any type of network interface, such as a modem, network interface card (NIC), wireless connection, etc. The network 110 can be any type of network topology, such as Internet or Intranet.

The network 110 supports the World Wide Web (WWW), which is an Internet technology that is layered on top of the basic Transmission Control Protocol Internet Protocol (TCP/IP) services. The client system 130 supports TCP/IP. The client system 130 includes a web browser for accessing and displaying the interactive presentation. It is desired that the web browser support an Internet animation or video format, and a such as Flash™, Shockwave™, Windows Media™, Real Video™, QuickTime™, Eyewonder™, a mark-up language, such as any dialect of Standard Generalized Markup Language (SGML), and a scripting language, such as JavaScript, Jscript, ActionScript, VBSscript, Perl, etc. Internet animation and video formats include audiovisual data that can be presented via a web browser. Scripting languages include instructions interpreted by a web browser to perform certain functions, such as how to display data.

An e-learning content creation station 150 stores the interactive presentation on the server 120. The e-learning content creation station 150 includes content creation software 150 for developing interactive presentations over a distributed computer system. The e-learning content creation station 150 enables access to at least one database 160 or file system. The database 160 stores interactive presentation data objects such as text, sound, video, still and animated graphics, applets, interactive content, and templates.

The client system 130 accesses the interactive presentation stored in the database 160 or from the server 120 using TCP/IP and a universal resource locator (URL). The retrieved interactive presentation data is delivered to the client system 130. At least one data object of the interactive presentation is stored in a cache 130-2 or virtual memory 130-4 location on the client system 130.

According to an embodiment of the present invention, the client system 130 is operated by a user (e.g. student) in an e-learning course. The e-learning course can relate to any subject matter, such as education, entertainment, or business. An interactive presentation is the learning environment or classroom component of the e-learning course. The interactive presentation can be a web site or a multimedia presentation.

Embodiments of this invention, such as the interactive presentation, or more specifically, the e-learning course product, are commercially available from Telecommunications Research Associates, LLC of St. Marys, Kans. and e-Learning courses produced by other organizations using this invention under license from Telecommunications Research Associates.

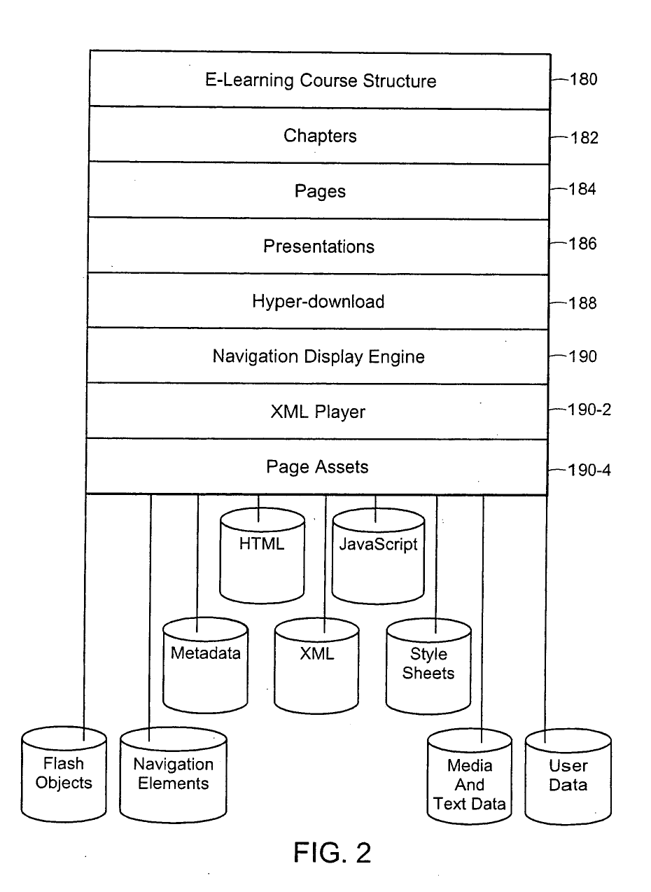

FIG. 2 is a block diagram illustrating the media components of the interactive presentation content according to one aspect of the invention. The interactive presentation provides an e-learning course structure layer 180. The e-learning course structure layer 180 defines the structure of the interactive presentation. The e-learning course structure layer 180 includes a chapter layer 182 that features chapters, sharable content objects consisting of one or more or lessons in the e-learning course. Each chapter layer 182 includes a page layer 184.

The page layer 184 represents the pages in the chapter layer 182. The pages illustrate the subject matter of the chapter. The subject matter is more particularly represented in a presentation layer 186, which provides instructional data, navigational tools and interactive exercises or assessments for the e-learning course.

A hyper-download layer 188 includes a pre-loading engine that systematically delivers specific layers of content from the interactive presentation to a memory location 130-4 or a scratch location 130-2, such as a browser cache.

The user input is detected by a navigation display layer 190. The navigation display layer 190 processes user input and displays the page layer 184 that corresponds to the user input.

When the navigation display layer 190 displays a page from the page layer 184 that is an Extensible Markup Language (XML) document, an XML layer 190-2 is used to process and display the page. The XML layer 190-2 consists of supporting files, such as JavaScript files. The XML layer 190-2 can parse XML data and render it into a format that the browser requires. Once the XML data is rendered by the XML layer 190-2, the navigation display layer 190 can display it in a browser user interface.

The page assets layer 190-4 consists of data objects that can be linked by the different layers of content in the interactive presentation. For example, page assets are referenced in the page layer 184 and the presentation layer 186. The data objects in the page assets layer 190-4 can provide instructional, navigational and interactive content. The data objects of the page assets layer 190-4 can include any form of web-deliverable content such as Flash objects, navigation elements, metadata, HTML, XML, JavaScript, style sheets, media and text data, and user data.

According to one aspect of the invention, the course structure layer 180 is an XML course structure file that defines the interactive presentation. The course structure layer 180 defines requirements, content and media assets associated with the layers of the interactive presentation. More particularly, the course structure layer 180 is divided into three sections: attributes, structure, and content.

The attributes section defines the course title, score identification, user interface properties, peripherals, and testing attributes. The score identification attributes allow the interactive presentation to track a user's scores on a particular interactive exercise. The user interface properties define the look and feel of: the table of contents, closed captioning region, toolbar, and navigational buttons. The peripherals define whether prerequisites are required to take the course, and whether the course has supplementals, objectives, job aids, and the like. For example, if the interactive presentation requires a user to have prerequisites, the attributes section of the course structure file determines whether prerequisites are required.

The course structure file defines the testing environment for the interactive presentation with the testing attributes. The testing attributes can define a mode associated with exercises or assessments. In particular, the testing attributes define the number of attempts a user can have at a test or exercise. The testing attributes further define whether answers, scores, remediation, or feedback can be displayed on the user interface. The testing attributes also determine whether a user can navigate incorrect answers and whether the user interface displays a check it button for an exercise.

The structure section defines the structure for the chapters 182, and the pages 184 within the chapters 182. In particular, the chapters 182 are further defined as folders in the course structure. Each folder is given a folder title. Each page 184 is referenced with an alias within a folder, such as <folder><page ref=‘c2-1’></folder>. With this structure for the folders (chapters) and pages, the XML course structure can point to every chapter 182 and page 184 in the course structure 180.

The content section defines the specific layers of content for the pre-loading engine of the hyper-download layer 188 to download. Specifically, each page in the page layer 184 is linked in the content section of the XML course structure file. An example of one page that is linked in the content section of the XML course structure file appears as follows:

```
<content>
      <c2-13>
      <title>Summary</title>
      <type>scriptedflash</type>
      <data ref=“c2-13.XML”/>
      <mediafiles>55916-0001.swf</mediafiles>
      </c2-13>
</content>
```

The page alias, <c2-13>, the title of the page, <title>Summary</title>, the type of page, <type>scriptedflash</type>, a data reference link, <data ref=“c2-13.XML”/>, and specific media files <mediafiles>55916-0004.swf</mediafiles>are referenced in the content section of the XML course structure file. In this example, some page assets 194 are referenced, such as the data reference link, which references an XML file, and the media file, which references a Flash, “swf file”.

The information in the course structure file can be stored in JavaScript arrays. Each page in the page layer 184 is a node in the JavaScript arrays. Each node can have corresponding attributes.

By storing the course structure in an course structure file (e.g. XML files) or in memory locations (e.g. JavaScript arrays), the interactive presentation can simplify the design of the course for a developer, and enhance the viewing experience for a user. In particular, the course structure file enables all components of the interactive presentation to be fully integrated with the course structure. Components such as navigational elements, menus, software components, and the like can retrieve the course structure directly from the course structure file. Each component can receive the most update information about the course structure with the course structure file. Furthermore, the course structure file provides a centralized approach to integrating and developing a multi-megabyte presentation.

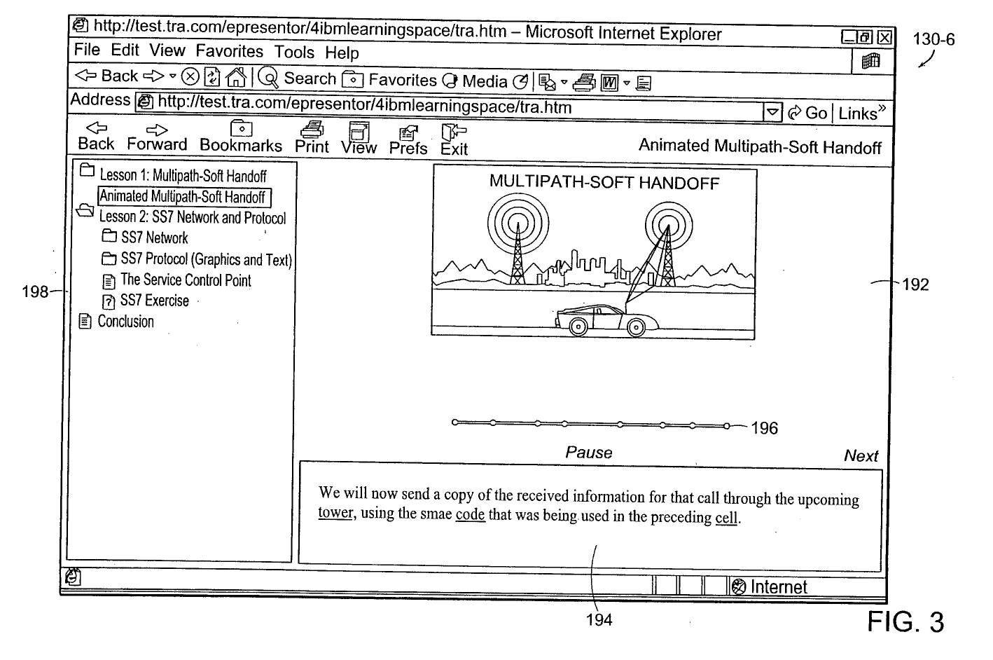

In FIG. 3, an interactive presentation is displayed in a browser user interface 130-6. In general, the layout of the user interface features four specific areas that display instructional, interactive or navigational content. These four areas are animation-video region 192, closed caption region 194, toolbar 196 and table of contents 198.

The animation-video region 192 can display any type of data object. For example, the animation-video region can display Flash objects, web-deliverable video, slide show graphics with or without synchronized sound, or static graphics with or without synchronized sound.

In addition to navigational tools, the animation-video region 192 of FIG. 3 can display interactive exercises and assessments. The types of interactive e-learning exercises and assessments are single question (dichotomous, multiple choice, multiple select) matching (puzzles, building blocks/compare and contract, drag and drop) and ordered list. Interactive exercises and assessments, such as multiple choice questions, are discussed in U.S. application Ser. No. 10/918,208, filed Aug. 12, 2004, which is incorporated herein by reference in its entirety.

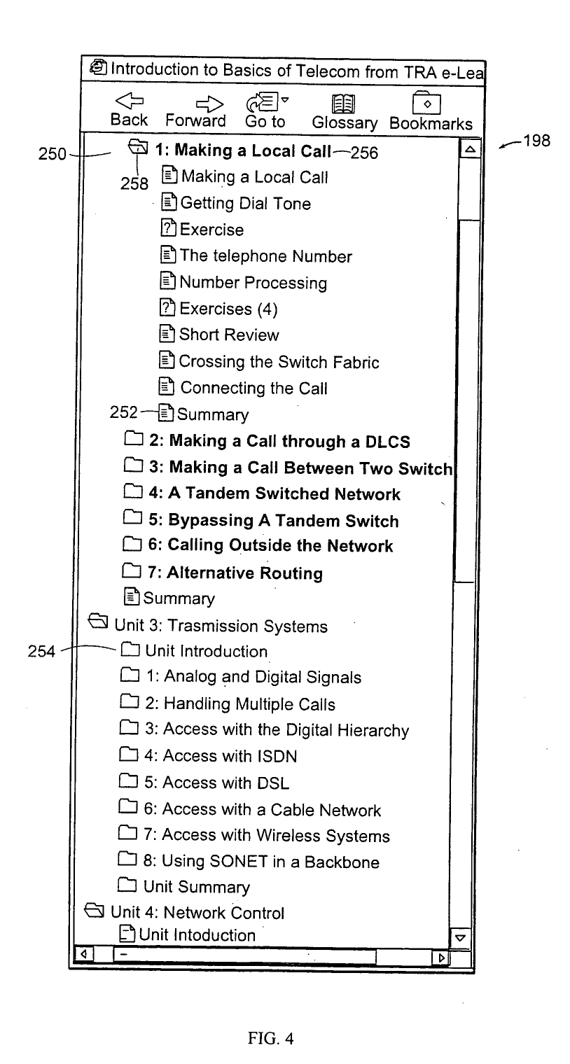

FIG. 4 is a diagram illustrating a table of contents 198 of the user interface 130-4. The table of contents 198 is a navigation tool that dynamically displays the course structure in a vertical hierarchy providing a high-level and detailed view. The table of contents 198 enables the user to navigate to any given page of the interactive presentation. The table of contents 198 uses the course structure file to determine the structure of the interactive presentation. The user can navigate the table of contents 198 via mouse interaction or keystroke interaction.

The table of contents 198 is a control structure that can be designed in any web medium, such as an ActiveX object, a markup language, JavaScript, or Flash. The table of contents 198 is composed of a series of data items arranged in a hierarchical structure. The data items can be nodes, elements, attributes, and fields. The table of contents 198 maintains the data items in a node array. The node array can be an attribute array. The table of contents 198 maps its data items to a linked list. The data items of the table of contents 198 are organized by folders, which correspond to chapters 250 (units or sections) and pages 252. Specifically, the chapters 250 and pages 252 are data items of the table of contents 198 that are stored in the node array.

Each chapter 250 is a node in the node array. Each chapter 250 has a corresponding set of attributes such as supporting folders (that correspond to lessons 254), pages 252, a title 256, indicators 258, and XML and meta tags associated with the chapter. The indicators 258 can indicate the state of the chapter 250. For example, an open chapter can have an icon indicator identifying the state of the open chapter.

Each page 252 is a supporting structure of a chapter 250. Each page 252 has a corresponding set of attributes such as supporting child pages, an icon that shows the page type, a page title, and any tags associated with the contents of the page 252. The pages 252 have page assets that can be tagged with XML and meta tags. The tags define information from the page assets.

When the user selects a chapter 250 within the table of contents, the navigation display engine toggles between an open state and a closed state. Specifically, the table of contents 198 either exposes or hides some of the attributes of the selected chapter.

When the user selects a specific page 252 (via mouse click interaction or keystroke interaction) from the table of contents 198, the browser displays the current page. The state of the current page 252 (such as the topic title 256) is displayed as subdued on the user interface 130-6, and an icon appears indicating the state of the page 252. The state 252 of the page indicates whether the page has been visited by the user.

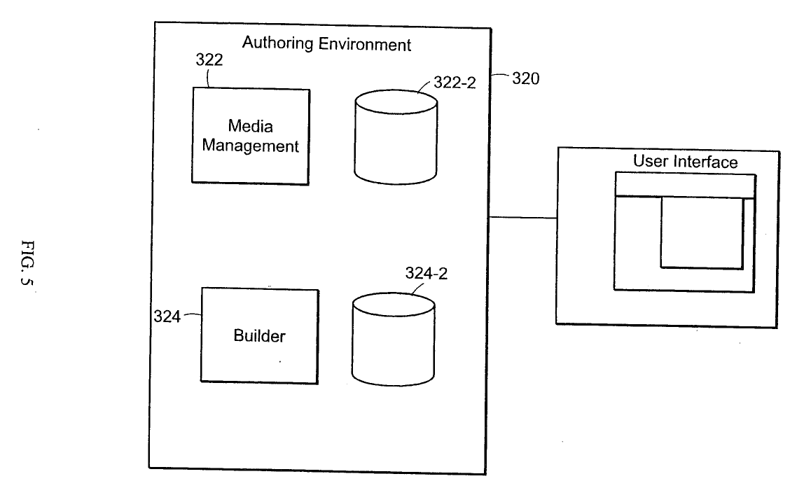

FIG. 5 is a block diagram illustrating the system architecture for creating an interactive presentation. A database authoring environment 320 allows the interactive presentation to be developed on a distributed system. The database authoring environment can create an interactive presentation product, and in particular, an e-learning product. The e-learning product can be used to create an e-learning course.

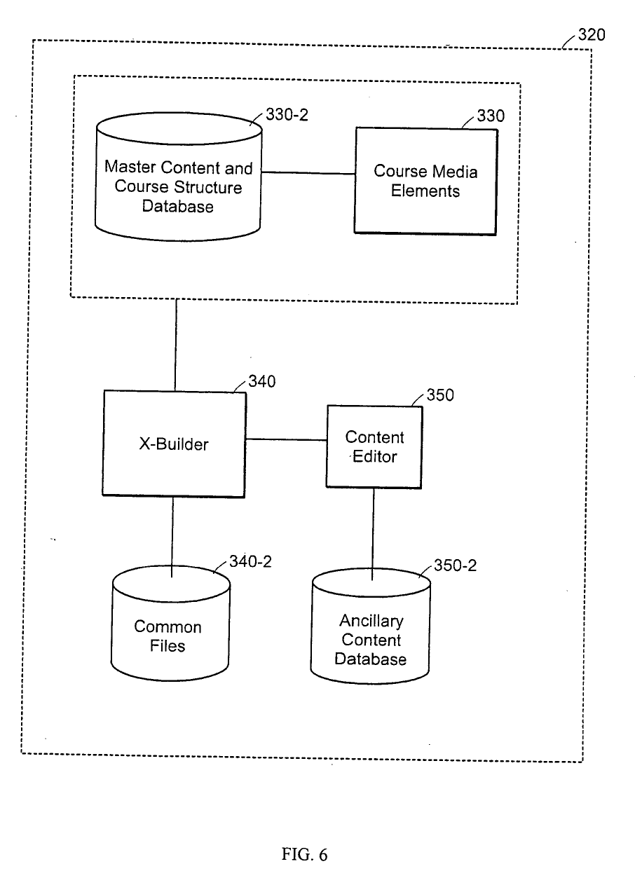

The database authoring environment 320 includes a media management module 322 and a builder module 324. The media management module 322 and builder module 324 include logic for authoring an interactive presentation. The modules can be applications, engines, mechanisms, or tools. FIG. 6 is a block diagram illustrating an embodiment of the database authoring environment 320 of FIG. 5. The database authoring environment provides a course media element (CME) application 330 and an x-builder application 340. The CME application 330 manages a master content course structure in the common files database 340-2. An x-builder application 340 manages a common files database 340-2 and an ancillary 350-2 content database.

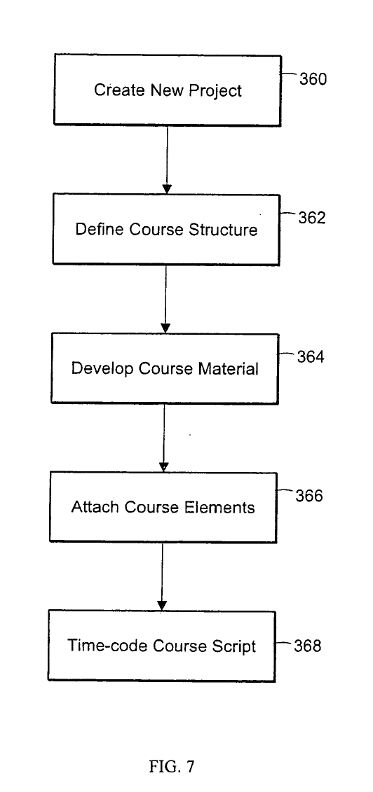

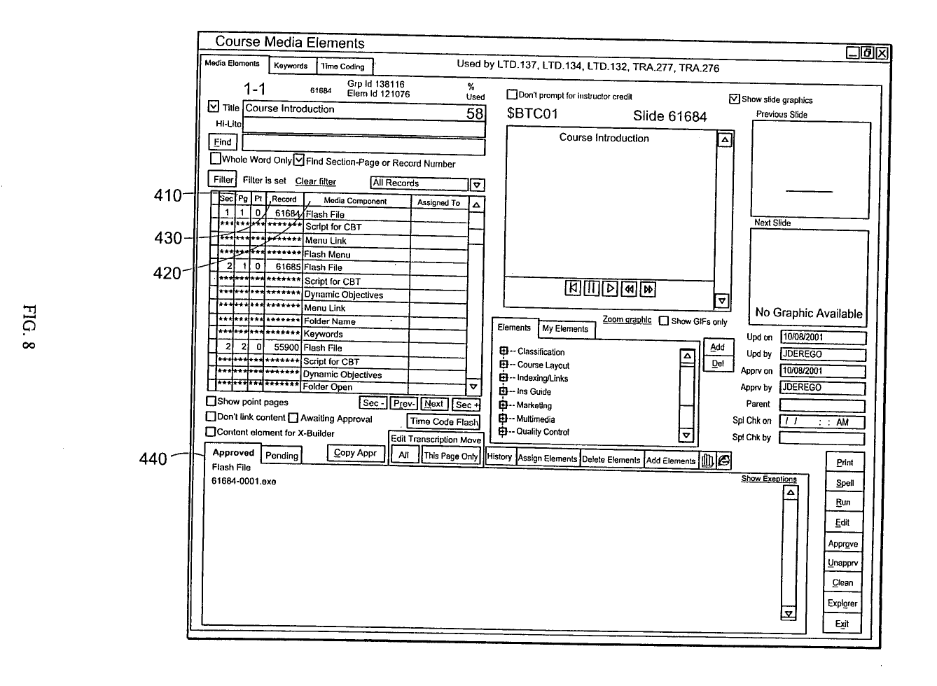

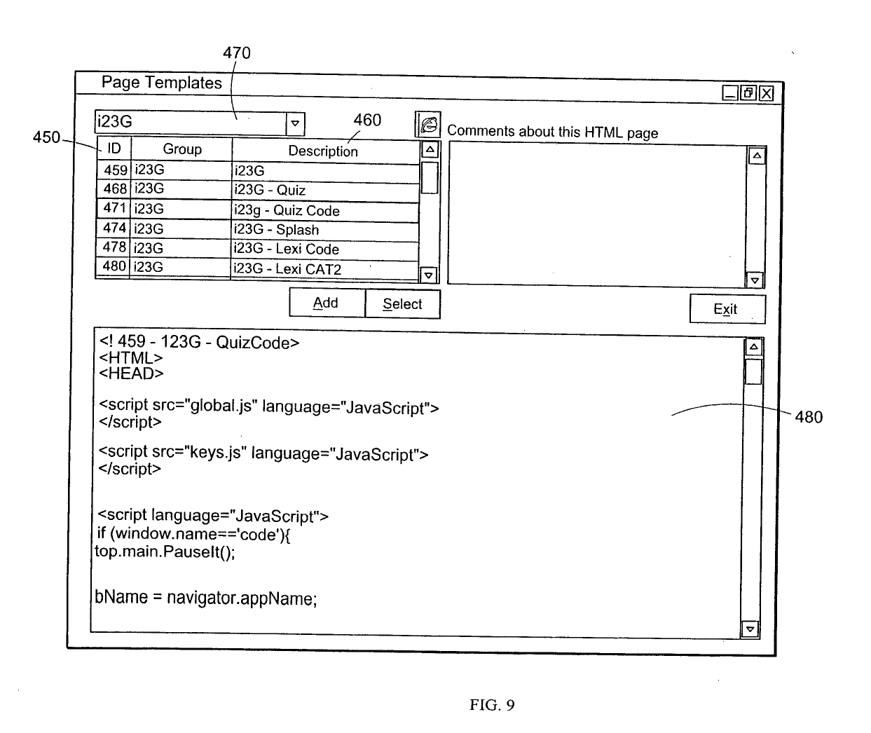

The CME application 330 can be used to develop and store a new course project. FIG. 7 is a flow diagram describing the steps of the CME application. At step 360, the CME application 330 creates a new course project for an interactive presentation. At step 362, the CME application 330 defines a course structure for the interactive presentation. The course structure is organized in a hierarchical arrangement of course content. For example, the CME application 330 can provide a hierarchical arrangement using a table of contents structure. The table of contents structure can be organized by chapters, and the chapters can include pages.

At step 364, the CME application 330 provides course material for the course project. The CME application 330 stores individual pages with page assets in a master content library. At step 366, the CME application 330 attaches the applicable page assets to each page in the e-learning course structure.

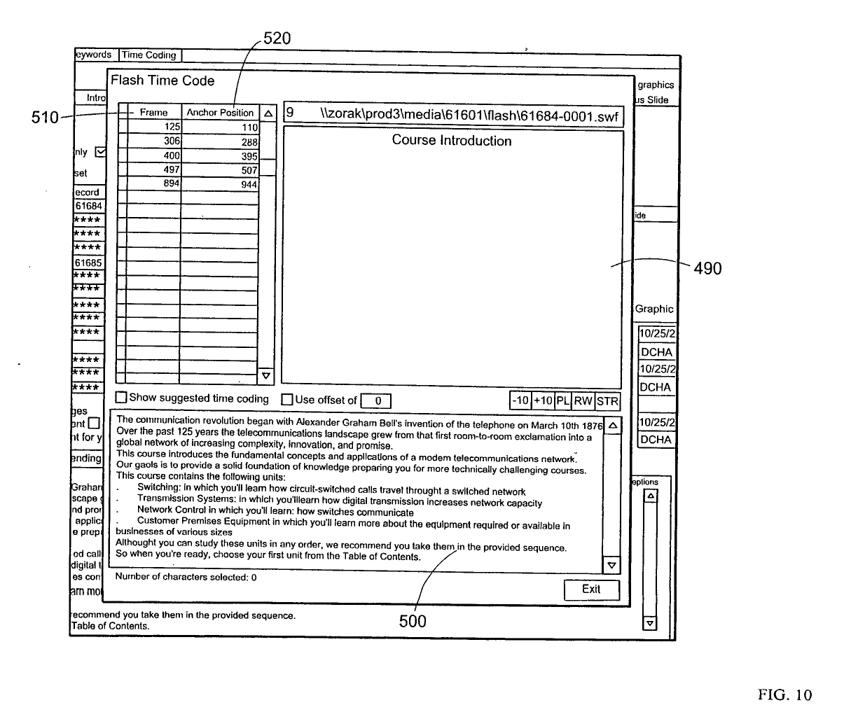

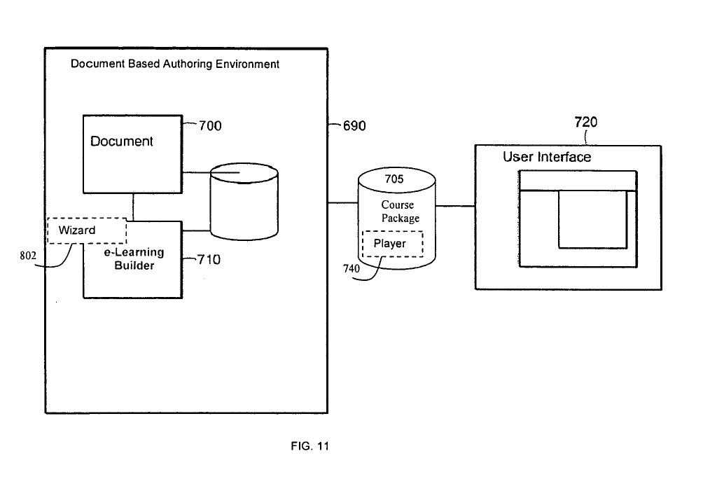

FIG. 10 is a diagram illustrating the time-coder interface of the CME application 330. The time-coder displays the animation/video region 490 and the closed captioning region 500 of the interactive presentation interface.

The time-coder can be used to synchronize closed caption text to content in an interactive presentation. With CME (or within a storyboard) a course developer can create a time code sequence for a group of pages in the presentation. When the time coding information has been inserted, the time coding information for the course project can be imported into the x-builder application 350-2.

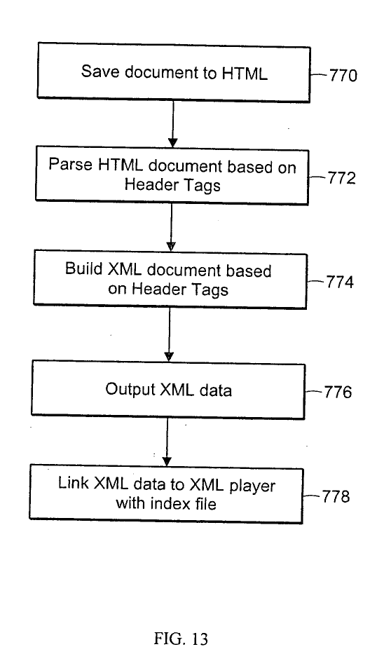

The x-builder application compiles the course project into the interactive presentation. FIG. 13 is a flow diagram describing the steps of the x-builder application. At step 530, the x-builder application 340 creates a new interactive presentation project.

At step 532, the x-builder application 340 imports the course project from the master content and course structure database 330-2 to the common files database 340-2. The x-builder application imports content from other modules in the database authoring environment. For example, the x-builder application 340 can import content from the ancillary content database 350-2.

The x-builder application content editor 350 manages the content stored in the ancillary content database 350-2. The x-builder application content editor 350 is a component application of the x-builder application 340. The ancillary content database 350-2 stores reference content such as templates, glossary assets, definitions, hyperlinks to web sites, product information, and keywords. For example, the reference content can include definitions for technology keywords in an e-learning course with technology subject matter. The x-builder content editor 350 maintains the integrity of the reference content stored in the ancillary content database 350-2.

When the x-builder application 340 imports content, such as page assets from the master content and course structure database 330-2 and reference content from the ancillary content database 350-2, the x-builder application 340 creates a distinct set of content for an interactive presentation project. The x-builder application 340 imports the content and stores the content in an interactive presentation product build directory on the common files database 340-2. By importing the content to the product build directory, the x-builder application 340 can isolate the content from any changes made to master content and course structure database 330-2.

The x-builder application 340 creates a dictionary for any key terms included in the imported content from the master content and course structure database 330-2 and the ancillary content database 350-2. The dictionary can be a partial dictionary or a complete dictionary. The partial dictionary is limited to the text data terms used in the new interactive presentation project created by the x-builder. The complete dictionary includes all terms that are stored in the ancillary content database 350-2.

The ancillary content database 350-2 can include terms from other interactive presentation projects. For example, the ancillary content database 350-2 can include approved technology terms from a previous technology related e-learning course.

At step 538, the x-builder application 340 executes the exception-based auto-hyperlinking system. The exception based auto-hyperlinking system can generate hyperlinks linking specific content in the interactive presentation project to glossary definitions or similar subject matter. The exception based auto-hyperlinking system is discussed in U.S. patent application Ser. No. 10/287,441 filed Nov. 1, 2002, U.S. Provisional Patent Application No. 60/494,760 filed Aug. 12, 2003 and U.S. Provisional Patent Application No. 60/530,457 filed Dec. 17, 2003, the entire teachings of which are incorporated herein by reference.

FIG. 11 is a block diagram illustrating the system architecture for creating an interactive presentation according to an embodiment of the present invention. The system architecture includes a document-based authoring environment 690 and a user interface 720. The document-based authoring environment 690 is an Automatic Storyboard™ concept that is a combination of a document 700 and a highly mobile desktop application referred to as the Automatic e-Learning Builder™ 710. The document 700 can be in any data processing or web authoring format such as a Microsoft Word, WordPerfect, HTML, Dreamweaver, FrontPage, ASCII, MIME, BinHex, plain text, and the like.

The storyboard document 700 can specify the content that should be included in the interactive presentation. For example, if the document 700 is a conventional Microsoft Word document, a user can insert text-based data objects such as text, closed caption script or HTML code. A user can insert into the document path/filenames to various non-text media, such as images, animation, audio or video. The Automatic e-Learning Builder™ 710 processes text-based data objects and converts the document 700 into an HTML document. The Automatic e-Learning Builder™ 710 copies the files containing the media data objects into directories of the course package 705. The Automatic e-Learning Player 740 (including any associated player files), course structure file, course directory, glossary, XML and HTML data, and media files are bundled into a course package 705.

According to an aspect of the invention, the document 700 is in a Microsoft Word format, and includes hierarchical headings defined by a Microsoft Word application. For example, text data can be formatted a certain way using the Microsoft Word headings. The Microsoft Word headings can define the structure of the document for the Automatic e-Learning Builder™ 710, which builds an equivalent course structure and course table of contents. The headings in the Microsoft Word document are converted to HTML header tags (<H1>, <H2>, <H3>, etc.). They can be converted by Automatic e-Learning Builder™ 710 or by a conventional Microsoft Word application.

Once the information is in HTML format, the HTML header tags define the structure of an XML document. Specifically, Automatic e-Learning Builder™ 710 uses the HTML header tags to instruct the XML player how to construct the interactive presentation. The HTML header tags can instruct Automatic e-Learning Player how to synchronize the display of the XML document page assets on the user interface 720.

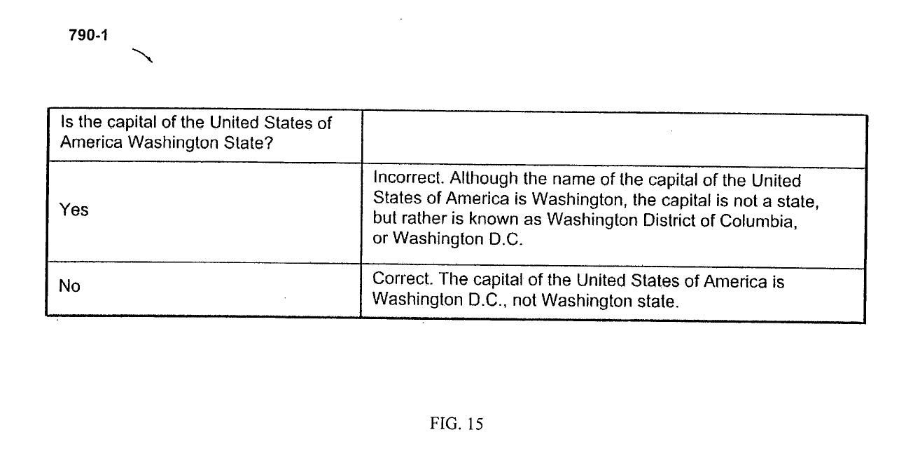

The HTML header tags can define the title for an interactive exercise or assessment. The HTML header tags can define the XML course structure file, and an XML table of contents. The HTML header tags can define new pages, such as the beginning and ending of pages. The HTML header tags enable Automatic e-Learning Builder™ 710 to arrange the data objects for display on the browser user interface 710. According to an aspect of the present invention, Automatic e-Learning Builder™ processes pseudo tags inside the HTML header tags (typically from the Microsoft Word headings) to determine how to build the XML document. For example, brackets such as { }, can be used in connection with the header tags to define further instruction for Automatic e-Learning Builder™ 710. Specifically, Automatic e-Learning Builder™ 710 can process such pseudo tags inside the header tags, and further determine the properties of the page. The tags can indicate the type of data on the page and can define the beginning and ending of a page. In comparison, for example, the x-builder uses a database to perform this. According to an embodiment of FIG. 15, the developer typically uses Microsoft Word to include the preceding course characteristics on Microsoft Word headings. Another method is for the developer to specify the preceding course characteristics directly in HTML header tags with an HTML editor.

Automatic e-Learning Builder™ 710 processes the tags in the HTML document 700 and places the HTML document 700 into an XML document. Automatic e-Learning Builder™ 710 builds the XML data based on the HTML header tags. By way of contrast, the x-builder 340 uses a database file (.dbf) to generate the XML data. The XML data defines a tree structure including elements or attributes that can appear in the XML document. Specifically, the XML data can define child elements, the order of the child elements, the number of child elements, whether an element is empty or can include text, and default or fixed values for elements and attributes, or data types for elements and attributes. It is preferable that the XML document is properly structured in that the tags nest, and the document is well formed.

The x-builder 340 and Automatic e-Learning Builder™ 710 both supply an XML player (Automatic e-Learning Player™) with the XML data from the above templates. The XML player compiles the XML data in the XML document for display in a browser on the user interface 720. In particular, a JavaScript program, that is included in the XML player, parses the XML data and displays it in a browser as HTML. The parser also utilizes parsing functions that are native to the browser.

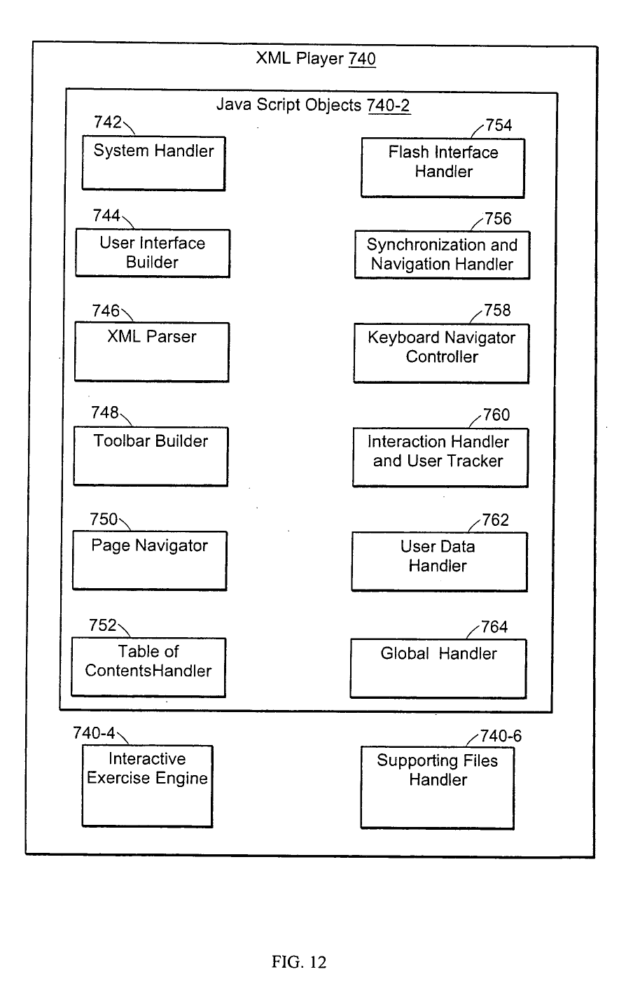

A diagram illustrating an embodiment of the XML player 740 is shown in FIG. 12. The XML player 740 is comprised of three general components: JavaScript programs 740-2, an interactive exercise engine 740-4 (written in a Flash ActionScript file) and other supporting files 740-6, such as GIFs, and HTML files.

The JavaScript programs 740-2 perform a variety of functions for the XML player 740. A system handler 742 audits the system requirements to make sure that the interactive presentation product can load on the client system 130. A user interface handler 744 builds the user interface for the interactive presentation product.

An XML parser 746 parses the XML data, such as XML data page assets, and builds an interactive presentation course structure file in memory. The XML parser processes the XML data and renders it into a format that the browser requires. The browser includes functions that are native to the browser that can assist the XML parser 746 in rendering the XML document. The browser then interprets the rendered XML document and displays it. The XML parser 746 also handles the XML data that are processed by the hyper-download system.

A toolbar builder 748 builds the main menu for the interactive presentation product. A page navigator 750 handles page navigation through the interactive presentation. A table of contents handler 752 provides table of contents navigation based on the course structure file. A Flash interface handler 754 setups the primary Flash interface. A synchronization and navigation handler 756 loads animations and creates the progress bar, and handles navigation of the closed captioning region of the user interface. A keyboard navigation controller 758 handles navigation events associated with keystroke interactions. An interaction handler and user tracker 760 tracks and scores user's interactions. A user data handler 762 handles user data such as cookie indicators that are stored on the client system 130 or on the server 120, such as the learning management sever. A global handler 764 handles commonly used subroutines. In general, the XML player's 740 interactive exercise engine 740-4 generates the interactive exercises or assessments, and handles communication with the user during the interactions. The XML player can be a web application.

According to an aspect of the present invention, the components of the XML player are bundled together into a plug-in for the browser. For example, the JavaScript programs 740-2, an interactive exercise engine 740-4 and other supporting files 740-6, such as GIFs, and HTML files, are bound together into an ActiveX DLL file, and installed into the browser. According to another aspect of the invention the XML player 740 is a Java Applet.

FIG. 13 is a flow diagram describing the steps of the document-based authoring system of FIG. 11. At step 770, the document-based authoring system saves a document file to HTML format. At step 772, the HTML document is parsed based on the heading tags. At step 774, an XML document is built based on the HTML tags. At step 776, the HTML document is output as XML data. At step 778, the XML data is linked to the XML player with an index file. The index file initiates the XML player by pointing it at the XML data. This launches the interactive presentation course.

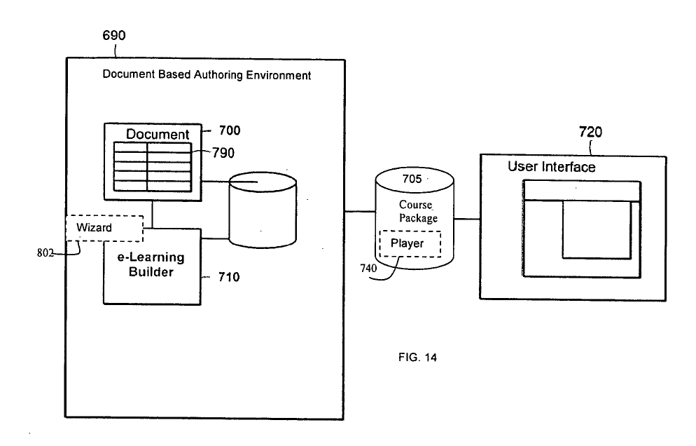

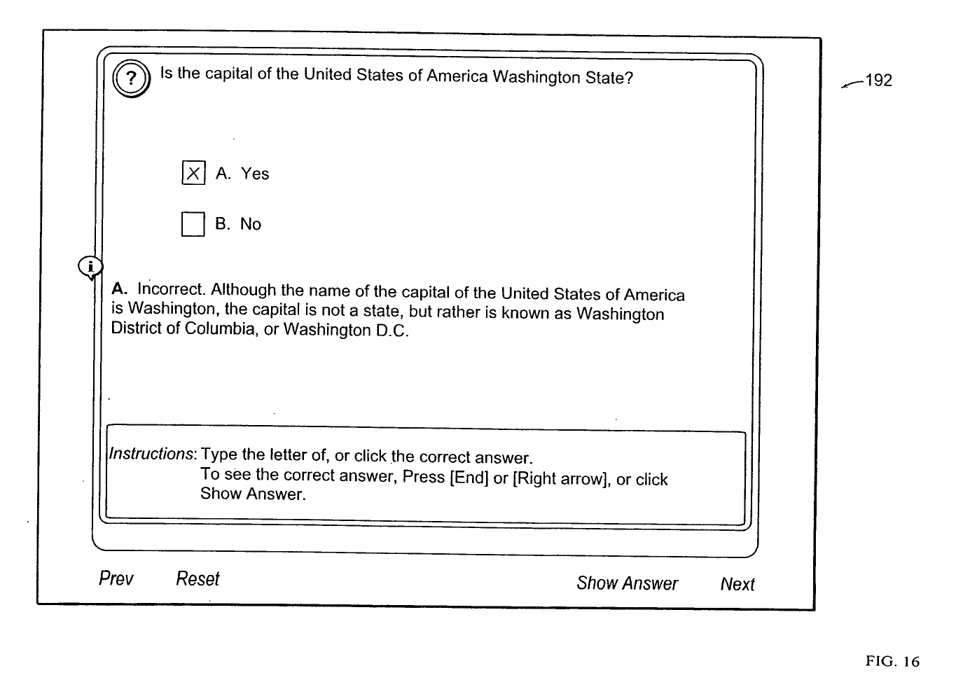

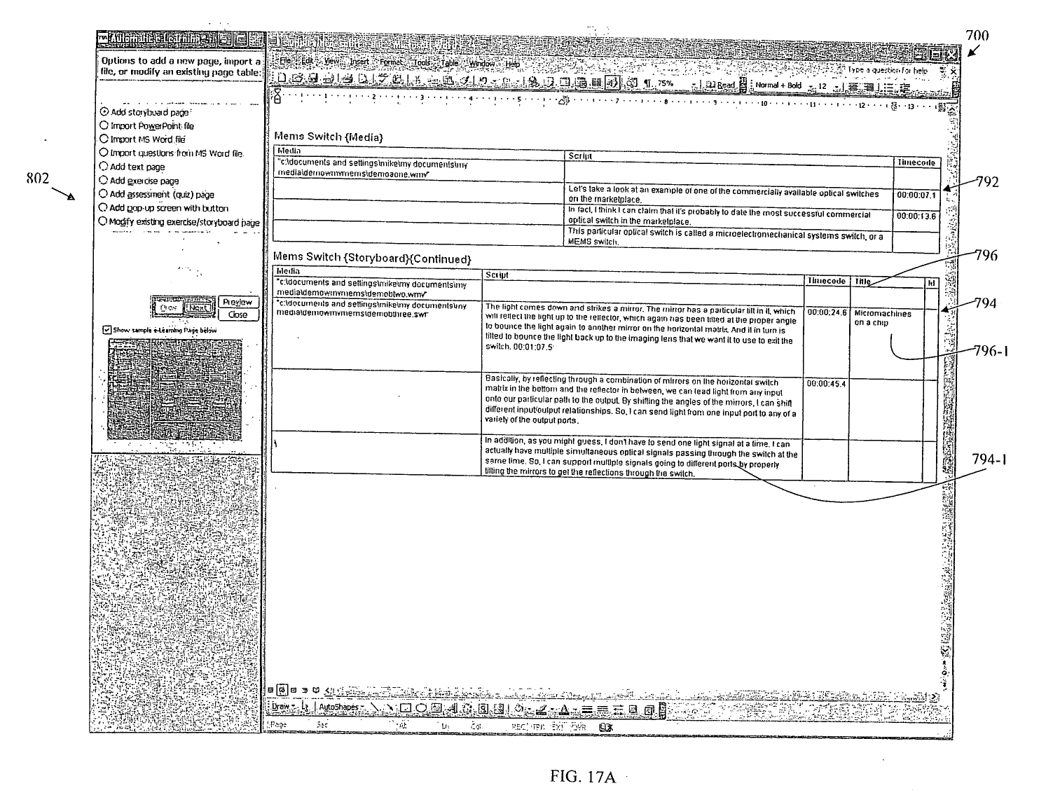

FIG. 14 is a block diagram illustrating an embodiment of FIG. 11. According to an aspect of the present invention, the document 700 includes a table 790. The document 700 can be any type of word processing document that can include tables. The table 790 can define a specific interactive exercise for the Player 720. For example, FIG. 15 is a diagram illustrating a table for a dichotomous exercise. The document 700 and its table are processed by the builder into HTML format, which is converted to a string embedded in an XML document. FIG. 16 is a diagram illustrating the table data of FIG. 15 in a dichotomous interactive exercise displayed on the animation-video region of the user interface. The text data in the cells of the table of FIG. 15 are integrated into the dichotomous interactive exercise.

According to an embodiment of FIG. 15, the HTML table 790 cells can include path/filenames of media elements, such as graphics, which the Automatic e-Learning Builder™ copies into a media directory in the course package. The player 720 can then arrange these images on the interaction screen.

For media or storyboard tables, the factors associated with the table 790 guide Automatic e-Learning Builder™ 710 on time-coding the animation video region, table of contents, closed caption region, and progress bar. Specifically, factors associated with the table 790 can instruct Automatic e-Learning Builder™ 710 as to how to synchronize the assets of the XML document displayed on the user interface.

Referring now to FIGS. 11 and 14, the document 700 based authoring environment 690 provides an alternative authoring environment to the x-Builder 340 of FIG. 6. In particular, the authoring environment 690 of FIGS. 11 and 14 has minimal database requirements, and as a result, it is highly mobile. This allows for offline development. Because the authoring environment 690 is primarily document 700 based, it provides an extremely flexible storyboard-based authoring environment that is highly desirable for instructional designers that work with subject matter experts in disparate locations. For example, data exchange is enabled via email, FTP, File Servers and Microsoft Word applications. Changes made to content in the storyboard are easily reviewed by using standard authoring tools, such as the track changes feature of Microsoft Word. Unlike other industry storyboarding processes, using the Automatic e-Learning Builder™ 710 the course designer can build a course directly from data stored in the document 700 itself, without having to be on the network and access a complex authoring system with a database containing the structure of the course or in order to (again) post the data to pre-defined screens and templates.

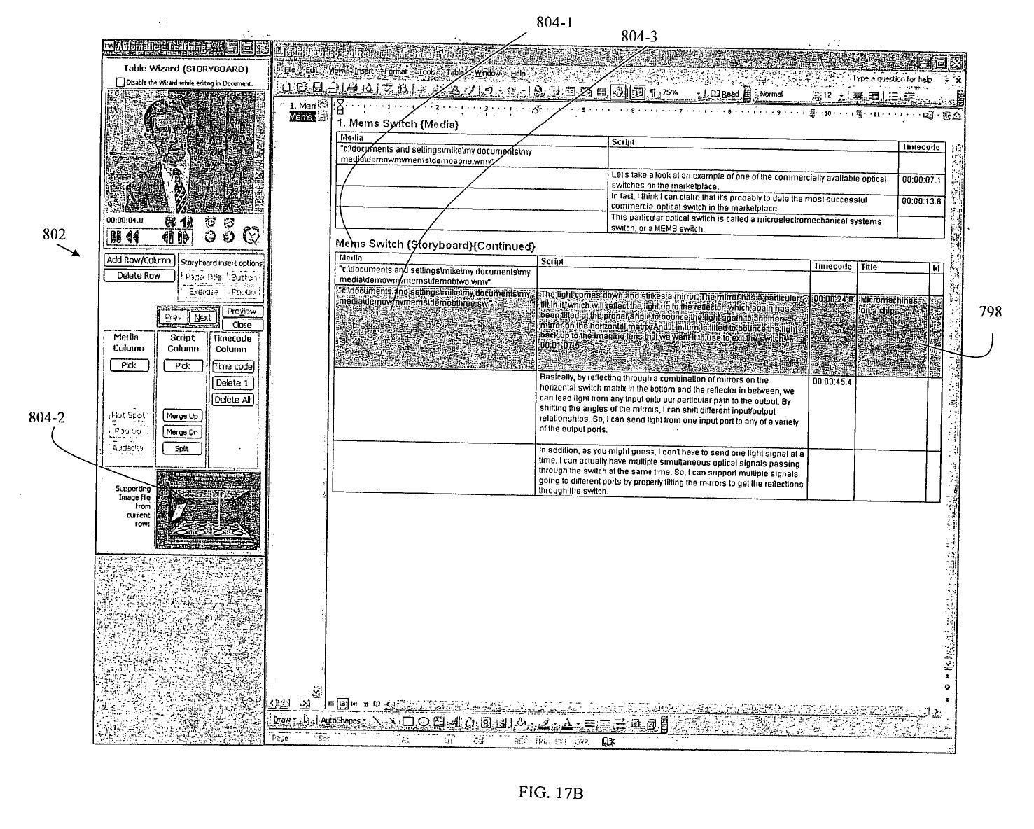

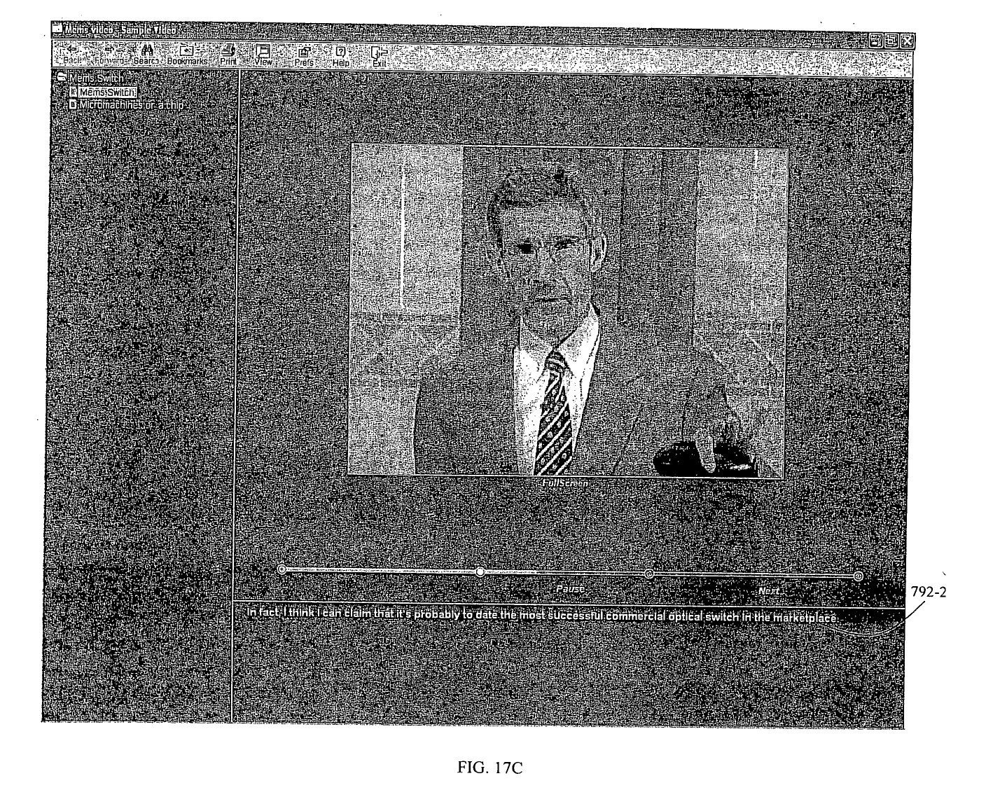

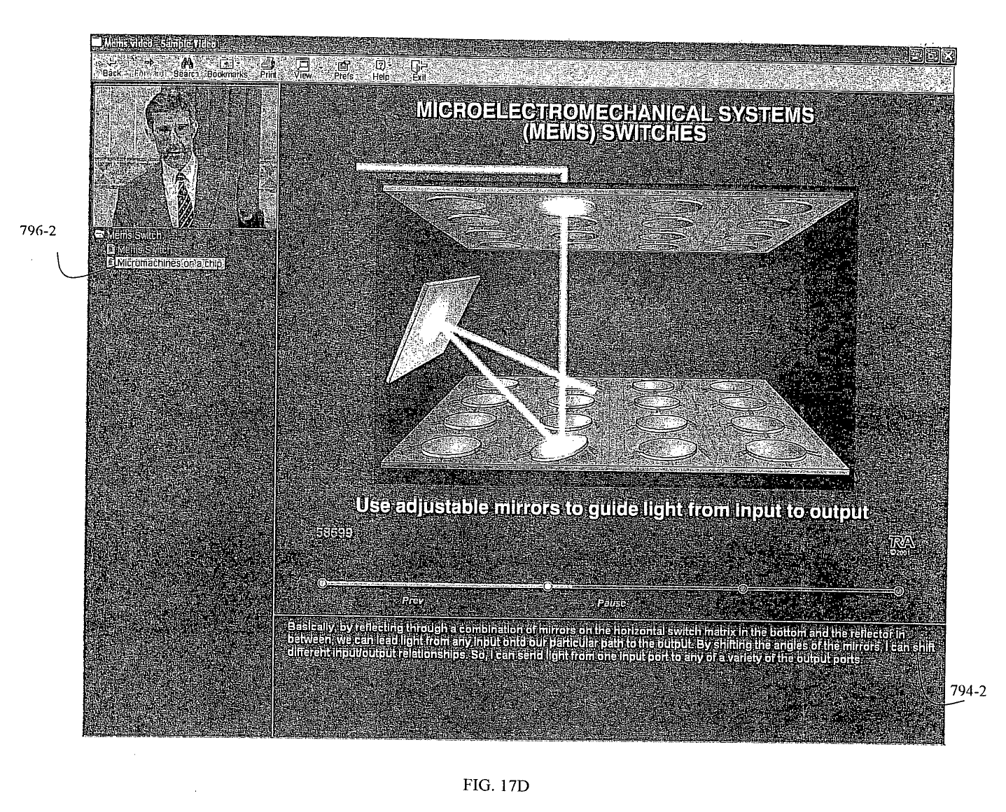

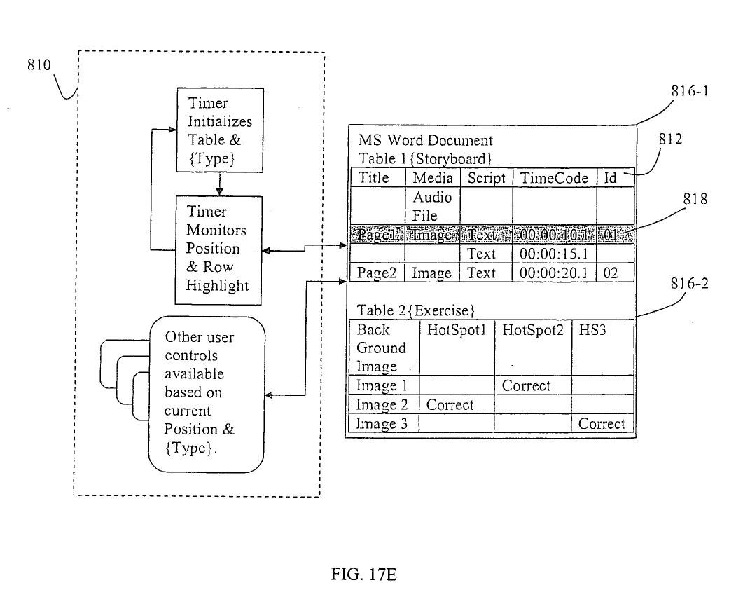

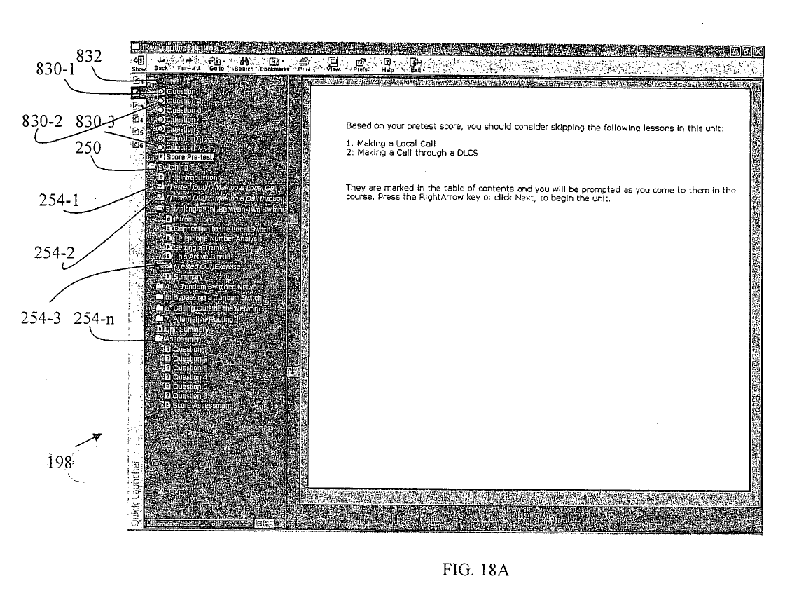

FIG. 17A is a diagram illustrating the interface used by the developer for creating an interactive presentation using a table wizard 802 according to an embodiment of the invention. While authoring can be done directly in Microsoft Word without any help, the table wizard 802 can provide easy manipulation of the document 700 for adding pages, creating storyboards, importing textual content, converting PowerPoint presentations to Flash files, and synchronizing script, graphics, animations, video and audio using time codes in connection with the document 700.

In this embodiment, the document 700 includes tables that can be used to create a presentation in different ways. A media table 792 is provided to create a presentation on a page-by-page basis. The media table 792 developmental approach provides an extremely user-friendly environment that is familiar to most developers and is directly compatible with existing documents already having a table of contents. Alternately, a storyboard table 794 is provided to create a presentation one lesson at a time. While the storyboard table 794 development approach is also an extremely user-friendly environment, it also matches how many instructional designers layout a course in a storyboard, as is used in the film industry. The storyboard table 794 also allows a media file, such as audio, video or animation to play across several sequential pages. The Automatic e-Learning Builder 710 can determine whether the table is a media table 792 or a storyboard table 794 by processing the headings above the respective tables. Specifically, the builder is responsive to a valid builder construct (e.g., {Storyboard}, {Media}, {Exercise}, {Pretest}, {Quiz}). Each lesson in the storyboard table can be identified by its respective lesson title 796, which appears in the title column (to be contrasted with the heading line that identifies page-at-a-time content).

When the table wizard program 802 is launched in connection with the document 700, an object reference to the document 700 is created and the Automatic e-Learning Builder 710 starts the table wizard 802 and calls the Microsoft Word automation server to open the document 700. The builder uses this object reference throughout the table wizard 802 to send commands to Microsoft Word and query current activity in the document. The table wizard 802 controls the document 700 using standard object linking and embedding (OLE) technology.

Typically in the past, when a program (which was not integrated with Microsoft Word) needed to modify a portion of the Word document or insert data into the Word document, it would usually launch a separate daughter window containing the respective data that needed to be inserted or modified. Consequently, this would require the instructional designer to toggle between different environments (e.g. the builder environment, the Microsoft Word environment and the table processing program's environment). Thus, it is desirable not to need to change environments.

It is not an easy task to determine a technique that enables the table wizard 802 to control the document 700 without having to change environments. In particular, a difficult part of the operation of the table wizard 802 is maintaining control over the document 700 while allowing the developer to manually and simultaneously make changes in the document 700 simply by selecting the left side of the screen (table wizard) or the right side of the screen (Microsoft Word). For example, if a media table 792 document is loaded, the table wizard 802 loads the media that contains a timeline (audio or video) and any supporting media (graphics). The developer is provided a visual indicator of the active row in the document 700 by highlighting it. For purposes of illustration, page row 818 is selected in the storyboard table 816-1. If the table wizard 802 had 100% control of the position and manipulation of the document, there would be no problems. However, because the developer also has read-write access to the document via Microsoft Word during the entire table wizard 802 session, the table wizard 802 must keep track of what it is doing, as well as where the developer is in the document and what the developer has changed. If the developer clicks on a row other than the highlighted row, the table wizard 802 has to detect this, remove the highlight from the previous row, highlight the new row, and display other data elements on the screen such as supporting media. Various buttons on the table wizard 802 form are active or inactive depending on the current position (row) in the document.

Alternatively, a developer may move off of one media table and select a cell in another media table, a storyboard table, an exercise or assessment table, or move to a text area anywhere else in the document. It should be noted that exercise tables are discussed in U.S. application Ser. No. 10/918,208, filed Aug. 12, 2004, which is incorporated herein by reference in its entirety. In moving from a media table to an exercise or assessment table, a refresh of the table wizard 802 will be needed, as well as toggling button states, reloading graphics/media, and possibly change the overall mode of the table wizard 802 based on the table type selected.

All of this communication is managed by a set of algorithms that are running inside of timer-based events on the table wizard 802 form control. Aspects of the table wizard 802, such as the form controls and the timer, can be implemented using FoxPro.

FIG. 17E is a block diagram of the table wizard using a timer process to control and manage the state of a word processing document. An initialization program first configures the form based on the current developer position in the document. An Id 812 is assigned to the initial table. This Id 812 is checked every time the table wizard 802 “checks” the document. Once the table wizard 802 is initialized, a timer 810 is turned on. This timer checks the document on a regular interval, for example, every 500 milliseconds. In another embodiment, the timer can be responsive to developer interaction, such as when the developer clicks the mouse or presses a cursor key or another key. The current selection in the document is checked. If the Table Id 812 has changed, the table wizard 802 is re-initialized. If a developer has moved their position in the current table 816-1, 816-2, the visual indicators are updated. If the developer has moved off of a table, the table wizard 802 attempts to re-load, or waiting until such time as a user selects a valid table to modify (e.g., Exercise, Pretest, Quiz, Media, or Storyboard).

The following is an excerpt of code from the timer event 810, which determines the current user's position in the document 810. This code verifies that the document is still active, determines which table and row the developer is working on, and decides whether or not to move the row highlight, load a new table, or exit the table wizard 802.

```
This.Enabled=.F.
This.Parent.TmrResize.Enabled=.F.
This.Parent.TmrTime.Enabled=.F.
l_lReturnWithNoTable=.F.
IF TYPE(“This.Parent.r_oWord”)!=“O” OR ISNULL(This.Parent.r_oWord)
        This.Parent.CmdNext.Click( )
ENDIF
IF TYPE(“This.Parent.r_oWord.Selection.Cells(1).RowIndex”)=“N” ;
        AND !EMPTY(This.Parent.r_cDocId) ;
        AND (TYPE(“This.Parent.r_oWord.Selection.Tables(1)”)=“U” ;
                OR (TYPE(“This.Parent.r_oWord.Selection.Tables(1)”)!=“U” AND
This.Parent.r_oWord.Selection.Tables(1).ID!=This.Parent.r_cDocId))
        This.Parent.r_lCheckTableintable = .T.
        This.Parent.m_HighlightRow(This.Parent.r_nTableRow,16777215)
        This.Parent.m_Imageopen(“ ”,.F.,.T.) && unload existing file
        This.Parent.r_cFile=“ ”
        IF TYPE(“This.Parent.r_oWord.Selection.Cells(1).RowIndex”)=“N”
                l_nRow=This.Parent.r_oWord.Selection.Cells(1).RowIndex
        ELSE
                l_nRow=−1
        ENDIF
        This.Parent.r_nTableRow=l_nRow
        This.Parent.m_Init( )
        RETURN
ELSE
        ** table is no longer the active selection so,
        ** try to load media table if clicked on Document map or on title
        IF TYPE(“This.Parent.r_oWord.Selection.Cells(1).RowIndex”)!=“N”
                ** get text of title
                IF !EMPTY(This.Parent.r_cFile)
                        This.Parent.m_Stopall( )
                        This.Parent.m_Imageopen(“ ”,.F.,.T.) && unload existing file
                        This.Parent.r_cFile=“ ”
                ENDIF
                This.Parent.m_HighlightRow(This.Parent.r_nTableRow,16777215) &&
change color back
                IF TYPE(“This.Parent.r_oWord.Selection”)=“O”
                        IF
EMPTY(This.Parent.r_oWord.Selection.Paragraphs(1).Range.Text)
                                TRY
                                        This.Parent.r_oWord.GOTO(11,3).Select
                                CATCH
                                FINALLY
                                ENDTRY
                        ENDIF
        l_cHeaderText=This.Parent.r_oWord.Selection.Paragraphs(1).Range.Text
                        * l_cHeaderText=This.Parent.r_oWord.Selection.Text && get title
text
                        IF ATC(“{media”,l_cHeaderText)>0 ;
                                OR ATC(“{studio”,l_cHeaderText)>0 ;
                                OR ATC(“{storyboard”,l_cHeaderText)>0 ;
                                OR ATC(“{exercise”,l_cHeaderText)>0 ;
                                OR ATC(“{quiz”,l_cHeaderText)>0 ;
                                OR ATC(“{exam”,l_cHeaderText)>0 ;
                                OR ATC(“{hotspots”,l_cHeaderText)>0 ;
                                OR ATC(“{test”,l_cHeaderText)>0 ;
                                OR ATC(“{pretest”,l_cHeaderText)>0
                                This.Parent.r_oWord.Selection.GoTo(2,2) && next table
                                IF
TYPE(“This.Parent.r_oWord.Selection.Cells(1).RowIndex”)=“N”
                                        IF
TYPE(“This.Parent.r_oWord.Selection.Cells(1).RowIndex”)=“N”
        l_nRow=This.Parent.r_oWord.Selection.Cells(1).RowIndex
                                        ELSE
                                                l_nRow=−1
                                        END IF
                                        This.Parent.r_cDocId=“*”
                                        This.Parent.r_nTableRow=l_nRow
                                        This.Parent.m_Init( )
                                        RETURN
                                ENDIF
                        ELSE
                                l_lReturnWithNoTable=.T.
                        ENDIF
                ELSE
                        ** word is no longer open
                        This.Parent.cmdCancel.Click( )
                        RETURN
                ENDIF
        ENDIF
ENDIF
```

FIG. 17B is a diagram illustrating the selection of a row in the storyboard table according to an embodiment of FIG. 17A. As shown in FIG. 17B, when a row 798 in the storyboard table 794 is selected, supporting media 804-3 specified in the media column 804-1 is processed by the builder 710 in connection with the player 740 and shown on the table wizard 802 interface and displayed 804-2.

Using the table wizard 802, the developer may:

add or remove rows
select and insert pointers (file name and path) to graphical files
select and insert pointers to audio/visual (movie) and animation files
specify that both a movie and animation file are to play simultaneously (on different parts of the screen)
import and partition (based on sentences, paragraphs or a developer-specified delimiter) closed-caption script
time-code the closed-caption script to the media
in storyboard, embed other page types (e.g., text pages, buttons, exercises, assessments, etc)
define hotspots for exercise or assessment or graphics
define dropzones for exercise or assessment

The advanced developer may, with or without the table wizard 802, perform any of the above tasks manually in Microsoft Word and even simultaneously in Microsoft Word with the table wizard 802 program actively monitoring the changes in the document.

The Automatic e-Learning Builder 710 transforms the contents of the document 700 to the data formats used by the player 740. For example, FIG. 17C is a diagram illustrating the page specified in the media table 792 of FIG. 17A. The script specified in media table cell 792-1 corresponds to the script 792-2 displayed in the presentation shown in FIG. 17C. FIG. 17D is a diagram illustrating the storyboard specified in the storyboard table 796 of FIG. 17A. The script specified in the storyboard table cell 794-1 corresponds to the script displayed in the presentation 794-2. The lesson name 796-1 corresponds to the lesson 796-2 in the table of contents (which is generated from the storyboard document).

Often, adult users who try to learn a subject on their own are unsuccessful, so they turn, in desperation, to asynchronous e-Learning. By the time they enroll in an asynchronous e-Learning course, they have learned some of the subject, perhaps quite a bit. Their knowledge makes much of the asynchronous e-Learning course repetitive, wasting the user's time and providing a boring learning environment.

The user's time can be saved, and the learning experience improved by letting the user test out of lessons that teach material that they already know. This requires e-Learning divided into lessons and a pretest question(s) associated with one or more lessons.

Referring to FIGS. 6, 14, and 17A-B interactive quizzes, in a database authoring environment 320 are referenced by ID at each lesson folder in CME 330 or in document-based authoring environment 690 placed within each lesson folder 796 in the chapter source document (storyboard document) 700. At build time, using the x-builder 340 or e-Learning builder 710, pretest interactions are extracted, while preserving the association to that particular lesson. At the beginning of each chapter, the player 740 presents the pretest items in a folder. The default name of this folder is “Pretest” and may be optionally changed by the author.

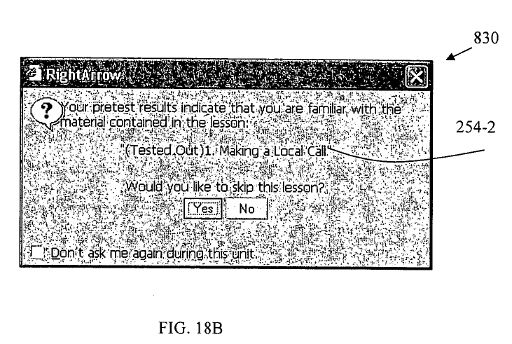

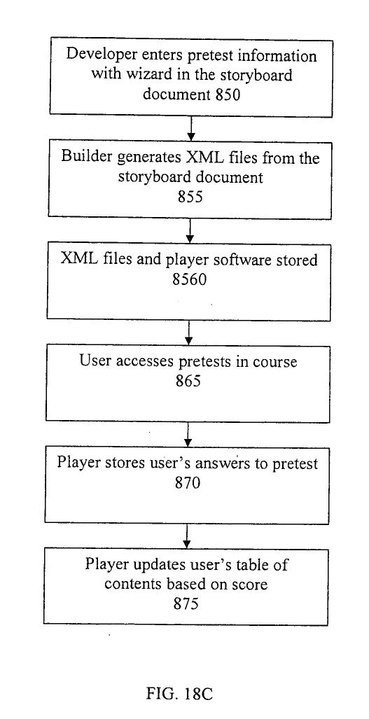

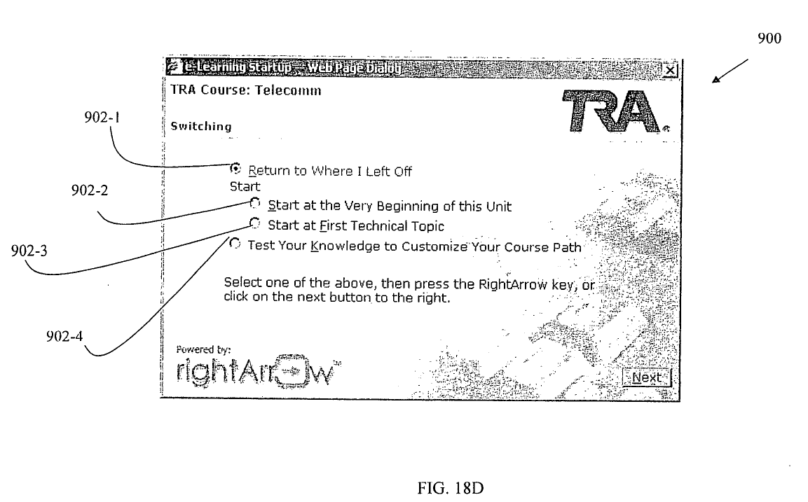

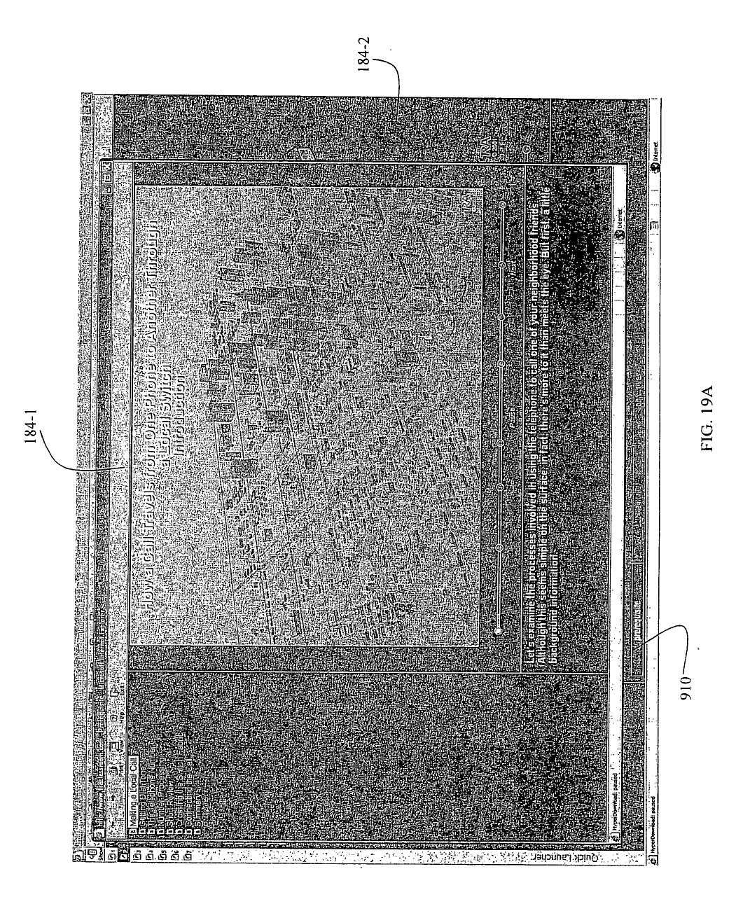

When a chapter or unit with pretest question(s) loads, the e-Learning startup page offers the user an option to take a pretest in order to customize their course path. FIG. 18D is a diagram illustrating a e-Learning startup page 900 in an interactive presentation. A shown in the startup page 900, user has the option to return where the user left off 902-1, start at the beginning of the lesson 902-2, start at the first technical topic 902-3, or customize their course path 902-4. The following discussion describes each of these options.
1) Return to where the user left off 902-1: XML Player 740 accesses the last page a user visited in their last session. This information is stored at the LMS or on the hard drive for CD-ROM users and updated each time the user leaves the course. This option would not be shown to new Users the first time they enter the course.
2) Start at the beginning of this unit 902-2: the database authoring environment 320 of FIG. 5 and the document-based authoring environment 690 of FIGS. 11 and 14 both provide the course developer with the option to label the page that begins the course overview. In the document-based authoring environment 690, the page title includes the construct {Overview} which is stripped out during transformation and stored as an XML data component on the page. In the database authoring environment 320, the course media elements 330 has an element record for this purpose. In either case, the XML data is the same and the XML player 740 reads the data in the course structure file.
3) Start at the first technical topic 902-3: Similar to the overview construct, the e-learning builder 710 looks for the construct {start} as the indicator for technical material. The {start} construct instructs the builder 710 to allow the user to skip the overview and go directly to the technical content in the course. The database authoring environment 320 provides an element record for this purpose. The XML data is stored in the course structure file and processed by the XML Player 740.
4) Test your knowledge to customize your course path 902-4: This option allows the user to proceed directly to the pretest. As described in reference to FIGS. 18A-C below, the results of the pretest enable the user to optionally skip lessons or post a score for the unit if they achieve, for example, a 100% score on the pretest.

If any of the XML data for these options (902-1, . . . , 902-4) is not there, the XML player 740 does not display the option in the startup page 900. If no options exist, for example, a first time user does not have a “last visited page” and there are no indicators for overview, first technical topic, or no pretest, the course begins without displaying the e-Learning startup 900.

When the user takes a pretest, the course can use the results of the test to evaluate the level of knowledge of the user. The player will use this information to determine which lessons the user may want to skip, marking these lessons as tested out of and when the user comes to one of these lessons, reminds the user and gives the user the option of not taking that particular lesson. In this way, the results of the pretest can enable the player to customize the users path in the course. At anytime, however, the user can open any the lesson folder and take any lesson including one that had been skipped or even successfully completed. FIG. 18A is a diagram of a course pretest page illustrating the situation where a pretest score changes the course path. As the user proceeds through the course, the table of contents 198 contains a visual icon showing mastery of each lesson if applicable. The checkmark icons followed by the string “(tested out)” 254-1, . . . , 254-3 on the table of contents 198 indicate lessons that the user can optionally skip. If a perfect score of 100% in the pretest is received, 100% is returned for the final test, allowing the user to skip entire chapter.

The user may pass part of the pretest, with the recommendation that they could skip lessons over which they have demonstrated mastery. The player 740 knows which lessons these are based on their original association with each Lesson Folder. This aspect of the invention is discussed in more detail below.

As the user navigates to each lesson, the player 740, if appropriate based on pretest results, prompts the user with a reminder that a lesson may be optionally skipped. The user may choose to ignore any such prompts, say by pressing the right arrow or return key, and the appropriate lesson will be automatically skipped. For example, FIG. 18B is a dialog box 830 indicating that a particular lesson 254-2 may be skipped.

Regardless of the pretest score, the user may choose to take all lessons in the course or may go into a lesson, even though their custom knowledge path suggests they may skip it. The user's path in the course is substantially dynamic. For example, the course allows the user avoid future lessons that the user has already successfully completed, and still provides the user with the option, at anytime, to open the lesson folder and take a test that the user previously tested successfully.

It should be noted that the XML player 740 functionality is the same, regardless of the authoring platform (x-builder 340 or e-Learning builder 710, or other).

There are some potential challenges when defining associations between the pretests 832-1, . . . , 832-n and their respective lessons 254-1, . . . 254-n. With traditional database development environments, relationships could be defined by associating a pretest with a respective lesson. However, developing e-learning courses in connection with relational databases requires a certain level of expertise. For example, one must be able to define a one-to-one relationships, such that if the referenced value changes, it changes for all referencing objects. With the document-based authoring system 690 provided in FIG. 11, however, no database is needed.

Because a relational database system is not required for the document-based authoring system 690 (although it could be used), a new technique is available for defining relationships between data, such as between a pretest and a lesson.

One would think that the pretests could be easily associated with their corresponding lesson by referencing the lesson page number or lesson title in the table of contents 198. A page number reference, however, does not specify where a multi-page lesson ends. In addition, a lesson title reference would not work after the lesson had been re-titled, for example, to make the titles consistent across a whole course or curriculum. Thus, the task of associating the pretests with the lessons is unstable when revising lesson names.

Using the mobile authoring environment 690 shown in FIGS. 11 and 14, a pretest is associated with a lesson using the Microsoft Word headings. In particular, the pretests are defined under the lessons at development time using Microsoft Word headings and the builder 710 uses these instructions to generate an XML file. In the database authoring environment 320, the course media elements 330 has an element record containing a list of the IDs of the questions for this purpose. The course structure file (csf.xml) generated by the Builder 710 or the Xbuilder 324 includes a page tag that contains a reference to the folder for which the pretest question is associated. For illustrative purposes, the code for a single page entry inside of the course structure file XML is shown below. As shown below, the scope property identifies the lesson folder to which the pretest exercise is associated with.

```
        <page id=‘223594-1000001880’ type=‘question’
        subtype=‘pretest’
scope=‘F172701’ resetable=‘0’>
                <rec>55997</rec>
                <title>Question 1</title>
                        <data ref=“c2-0-2.xml”/>
                <attributes>attempts=1,checkit=y,showanswer=n,
        feedback=n,rem=n,showscore=n,surfwrongs=n</attributes>
        </page>
```

Using the mobile authoring environment 690 shown in FIGS. 11 and 14, the course may be developed so that it is structured at development time using the Microsoft Word headings in the document 700. In particular, the course developer can easily partition a learning module into lessons, by beginning every lesson with a title specified in a Microsoft Word heading at a high level, e.g. level 1. Following the lesson title, is the material for each lesson, each page of which begins with a title specified in an Microsoft Word heading at a subordinate level, e.g. level 2. In media table 792 normal MS Word headings are used. In storyboard table 794 the Title column provides page headings. This can be normal text, or to create a hierarchical lesson, the title column contains an MS Word headings at the appropriate level.

The headings provide instructions to the builder in determining the structure of the course. When either the builder 710 or the Xbuilder 324 creates the course, it processes the pretests in connection with its corresponding lesson, and thus, knows its association in the course, assigns a pointer at build time, and generates the course so that the pretest appears at the beginning of the course, while preserving all associations.

It should be noted that at development time, the pretests are associated with lessons. However, at run-time, the organization of the lessons and the pretests are conceptually rearranged. Because a user often takes several pretests from the outset in the course, the pretests preferably appear at the beginning of the learning module. For example, in FIG. 18A, the pretest folder 832 contains a plurality of pretests 832-1, . . . , 832-n, and each pretest corresponds 832-1, . . . , 832-n, to a particular lesson. The pretest folder 832 is provided at the beginning of the course so that the player 740 can determine which lessons 254-1, . . . 254-n out of which the user will test.

FIG. 18C is a flow diagram of the process of including pretest question(s) within a lesson at development time. At 850, the developer enters pretest information in the storyboard document. The developer could use the wizard to enter the pretest information in the document. The pretest questions, for example, are provided after the lesson heading, with a subordinate heading level in the table. A test question can be specified in a Microsoft Word table preceded by an Microsoft Word Heading that includes the characters {test} or for a pretest {pretest}.

Another method for the developer to specify the reference between a pre-test question its associated Lesson is to place the pre-test question at the top of the document and insert a Microsoft Word cross-reference mapping to the lesson folder heading. The same XML as above would be generated. The resulting pretest question header in HTML contains a reference to the anchor point in the document where the lesson folder starts. In this example, a pretest question has a mapping reference to anchor id_Ref91639498.

<h2>Question{Pretest}<!--[if supportFields]><span style=‘mso-element:field-
begin’></span>REF _Ref91639498 \h <span style=‘mso-element:field-
separator’></span><![endif]-->Lesson 1: Data<!--[if gte mso 9]>
<xml> <w:data>08D0C9EA79F9BACE118C8200AA004BA90B02000000080000000
D0000005F00520065006600390031003600330039003400390038000000</w:data>
</xml><![endif]--><!--[if supportFields]><span style=‘mso-element:field-
end’></span><![endif]--></h2>

The lesson folder itself will contain a matching anchor reference.

<h2><a name=“_Ref91639498”>Lesson 1: Data</a></h2>

By generating cross-reference mappings at build-time, an association between the pretest question and the lesson specified in the Microsoft Word document can be converted by the e-learning builder into the HTML/XML output.

At 855, the builder generates XML data from on the storyboard document. (Alternately the developer can use CME application 330 to specify pretest questions and the associations from lessons to specific pretest questions, then use Xbuilder 324 to generate XML data.) At 860, the xml data and player are stored, for example, on a server or disk. The xml data includes the course structure file, which includes the associations between the pretests and their respective lessons. At 865, the user accesses the interactive presentation course. The pretest questions appear at the beginning of the course module. At 870, the user's results from the pretest are stored. For example, the player software, in communication with the browser, stores this saved data. At 875, the player updates the table of contents based on the user's pretest results. Any lessons, for instance, that the user tested out of will be marked as such. The user may also be reminded with messages during the course instructing the student that they may skip a particular lesson because the user tested out of the material.

The association of a pretest with a particular lesson enables a user to create a custom path throughout the course. Upon successful answering of a lesson's pretest question(s), the material to be skipped is exactly the material in the in the containing heading. For example, the developer creates an Microsoft Word document with headings as follows:
Heading 1 Unit I
Heading 1.1 Lesson 1
Heading 1.1.1 Page 1 of Lesson 1
   Material for Page 1 . . .
Heading 1.1.2 Page 2 of Lesson 1
   Material for Page 2 . . .
   Say 10 more pages
Heading 1.1.13 Question 1 {Pretest}
   Question 1 of 2 to test out of Lesson 1 specified
Heading 1.1.14 Question 1 {Pretest}
   Question 2 of 2 to test out of Lesson 1 specified
Heading 1.2 Lesson 2
Heading 1.2.1 Page 1 of Lesson 2
   Material for Page 1 . . .
Heading 1.2.2 Page 2 of Lesson 2
   Material for Page 2 . . .
   Say 5 more pages
Heading 1.2.8 Question 3 {Pretest}
   Question to test out of Lesson 2 specified
Heading 2 Unit II
Heading 2.1 Lesson 3
Heading 2.1.1 Page 1 of Lesson 3
   Material for Page 1 . . .
Heading 2.1.2 Page 2 of Lesson 1
   Material for Page 2 . . .
   Say 3 more pages
Heading 2.1.6 Question 4 {Pretest}
   Question to test out of Lesson 3 specified

At run-time, the user, after opening the Optional Pretest, Unit I and Unit II folders, the table of contents appears as follows.
Optional Pretest
Question 1
Question 2
Question 3
Question 4
Unit I
Lesson 1
Lesson 2
Unit 11
Lesson 3

A course structure file is used to describe, in a hierarchical format, the curriculums, courses, and lessons in the library of content. The format of the course structure file is critical because it defines the relationships in the content. Below is an example of a course structure file in an XML format.

```
        <?xml version=“1.0” encoding=“ISO-8859-1” ?>
      - <courseind>
      - <TRX100 dur=“27.5 H” curriculaInd=“03” courseInd=“08”
customerId=“TRX100”>
        Understanding Network Fundamentals
        <SCO1 dur=“4 M”>Network Fundamentals Introduction</SCO1>
        <SCO2 dur=“42 M”>Switching</SCO2>
        <SCO3 dur=“30 M”>Transmission Systems</SCO3>
        <SCO4 dur=“27 M”>Network Control</SCO4>
        <SCO5 dur=“27 M”>Customer Premises Equipment</SCO5>
        <SCO6 dur=“38 M”>Basics of Data Communications</SCO6>
        <SCO7 dur=“72 M”>Layered Protocols</SCO7>
        <SCO8 dur=“30 M”>Characteristics of Packet Technologies</SCO8>
        <SCO9 dur=“54 M”>Local Networks and LANs</SCO9>
        <SCO10 dur=“16 M”>Access to WANs</SCO10>
        <SCO11 dur=“71 M”>WAN Core Technologies</SCO11>
        <SCO12 dur=“89 M”>The Internet</SCO12>
        <SCO13 dur=“37 M”>Business-Focused Technologies</SCO13>
        <SCO14 dur=“69 M”>Residential-Focused Technologies</SCO14>
        <SCO15 dur=“1.6 H”>Emerging Internet Applications</SCO15>
        <SCO16 dur=“1.5 H”>Optical Networking</SCO16>
        <SCO17 dur=“33 M”>Network Convergence</SCO17>
        </TRX100>
      - <TRX101 dur=“17.3 H” curriculaInd=“03” courseInd=“02”
customerId=“TRX101”>
        Understanding the Basics of Data Communications
        <SCO1 dur=“23 M”>Course Overview</SCO1>
        <SCO2 dur=“1.7 H”>Basics Concepts and Transmission of Data</SCO2>
        <SCO3 dur=“72 M”>Layered Protocols</SCO3>
        <SCO4 dur=“33 M”>Characteristics of Packet Technologies</SCO4>
        <SCO5 dur=“54 M”>Local Networks and LANs</SCO5>
        <SCO6 dur=“54 M”>Business/Residential Access to WANs</SCO6>
        <SCO7 dur=“82 M”>WAN Core Technologies</SCO7>
        <SCO8 dur=“1.6 H”>The Internet</SCO8>
        </TRX101>
      - <TRX101 dur=“17.3 H” curriculaInd=“05” courseInd=“01”
customerId=“TRX101”>
        Understanding the Basics of Data Communications
        <SCO1 dur=“23 M”>Course Overview</SCO1>
        <SCO2 dur=“1.7 H”>Basics Concepts and Transmission of Data</SCO2>
        <SCO3 dur=“72 M”>Layered Protocols</SCO3>
        <SCO4 dur=“33 M”>Characteristics of Packet Technologies</SCO4>
        <SCO5 dur=“54 M”>Local Networks and LANs</SCO5>
        <SCO6 dur=“54 M”>Business/Residential Access to WANs</SCO6>
        <SCO7 dur=“82 M”>WAN Core Technologies</SCO7>
        <SCO8 dur=“1.6 H”>The Internet</SCO8>
        </TRX101>
      - <TRX102 dur=“18.0 H” curriculaInd=“03” courseInd=“06”
customerId=“TRX102”>
        Understanding Voice Communications: A Technical Introduction
        <SCO1 dur=“6 M”>Communication Networks</SCO1>
        <SCO2 dur=“1.7 H”>Telephony Network Basics</SCO2>
        <SCO3 dur=“3.7 H”>Transmission Systems</SCO3>
        <SCO4 dur=“43 M”>Switching</SCO4>
        <SCO5 dur=“2.8 H”>Network Control</SCO5>
        </TRX102>
      </courseind>
```

The hierarchical format of the course structure provides a number of features that enables a user to learn more efficiently. The course structure file organizes the course content according to a hierarchy based on, for example, chapters, lessons and pages. Each node in the hierarchy may have one or more prerequisite nodes. As discussed in more detail below, this organizational structure facilities the development and implementation of the interactive presentation.

In today's information age, while employers need their personnel to be appropriately trained, they want them to spend as little time on the training as possible, in order to allow more time to be spent on accomplishing the organization's goals. Therefore, the ability to actually reduce the time that users spend on asynchronous e-Learning training is very valuable.

Users may need to know extensive information to perform their job. One approach to providing this training is known as prescriptive training. This requires a training advisor not only to determine the skill and knowledge required for a given job function, but also to assess, individually, each user's gaps in skill and knowledge and map out appropriate courses. For example, the training advisor must select not only a specific advanced level course, and the intermediate level courses that are prerequisites, but also the introductory courses that are prerequisites to the intermediate level courses, for example.

There are several problems with the prescriptive approach. Requiring a training advisor to map out courses individually for every user is a labor-intensive process. Once a user begins the training, there is no simple way to modify the plan based on the learning experience.

According to an embodiment of the invention, a dynamic prerequisites approach is used. Prerequisites for each lesson of each course are identified. These prerequisites can be another lesson or unit in this course, or another course, or even another entire course. The high-level courses and prerequisites might be determined by a training advisor. The other prerequisites could be determined once, and provided by the content provider to all the organizations using that content.

The prerequisites are typically iterative, and can be expressed as a directed acyclic graph (DAG) or a directed tree. The course structure can be built based on the prerequisites. Prerequisites for a particular lesson in an advanced course, for example, may require certain intermediate and introductory courses. Instead of starting off with the introductory course, a user can start in a lesson of an advanced course. In particular, the user can bypass the introductory and intermediate courses and access the advanced courses directly. Concepts discussed in the advanced course, which are also discussed at a more rudimentary level in any of the prerequisite courses, are linked throughout the advanced course. In this way, if the user encounters a concept in the advanced course that the user does not fully understand, the user can access the prerequisites to that advanced concept to study the fundamentals for that concept, which are discussed in the prerequisite lessons, effectively a tutorial. After the user is comfortable with that subject matter, the user can return to the advanced course. In this way, the learning experience can be optimized and customized to the level of knowledge of the user.

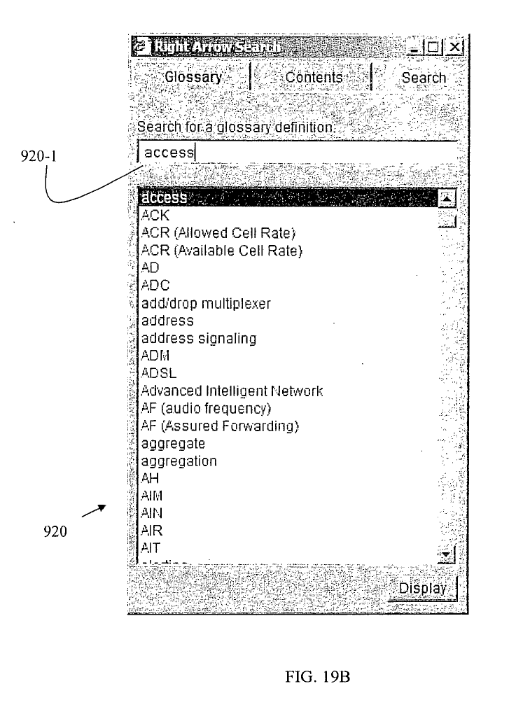

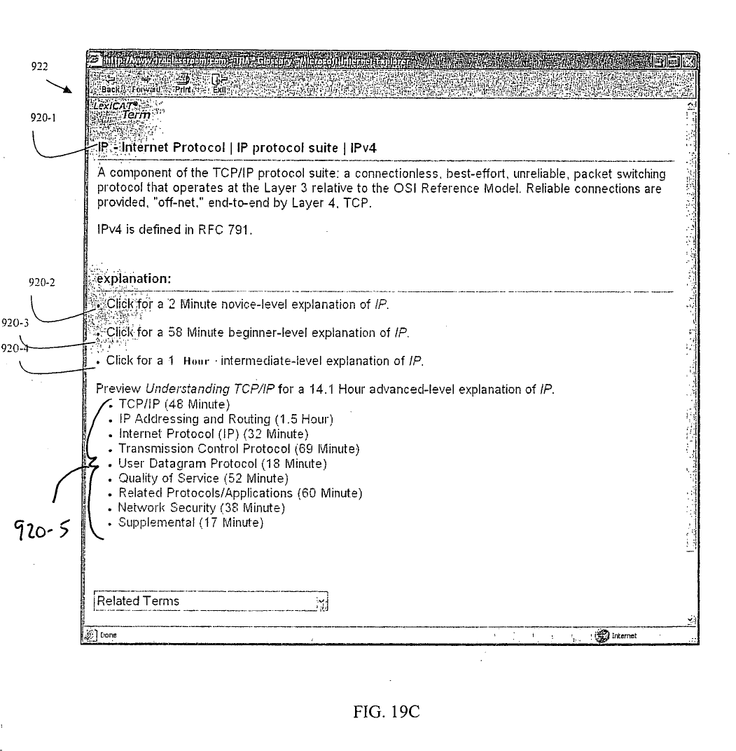

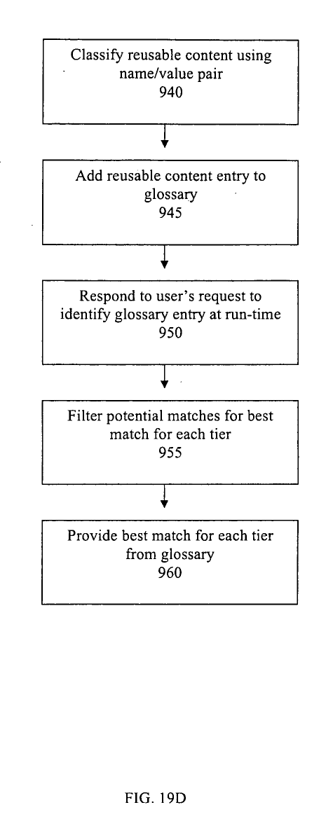

FIG. 19A is a diagram of a page 184-1 in an introductory course that has been requested by the user from a prerequisite link on page 184-2 in an advanced course. The page 184-2 in the advanced course includes a link 910 to a related page 184-1 in the prerequisites for that course, which relate to the concept discussed in the page 184-2 of the advanced course. It is desirable to avoid user confusion as to whether they are viewing the original material, or a tutorial, perhaps from another course. To avoid this confusion, the tutorial is placed in a separate daughter window 184-1 with the original window partially visible 184-2. Closing the daughter window 184-1 returns to the original course 184-2 in the place where the user left off.

Although prerequisites can be provided, determining prerequisites in advance can be labor intensive. For example, the curriculum manager may need to search each course for concepts that might need more fundamental tutorials. Then every available course is searched looking for portions that can be used as tutorials. This process of identifying prerequisites would need to be repeated for every course.

According to another embodiment of the invention, a dynamic prerequisites approach can be implemented using the glossary. Concepts or terms discussed in the closed caption region of the interface can be linked to the glossary. Alternatively, a user can access the concepts or terms by searching the glossary. Thus, when a user needs more information, they can click on the problem term in their course, or click on the toolbar search glossary and click the term (either action launches a glossary window). In addition to a normal definition of the term, the glossary window can include links to different levels of explanation for its term.

FIGS. 19C is a diagram of the glossary providing different levels of explanation of a term. FIG. 19B is a diagram of a search process 920 is provided that enables the user to search for a particular term 920-1. The search results of the term show not only a definition of the term, but a link 920-2 to a daughter window that provides an explanation of the term 920-1. As shown in FIG. 19C, various levels of explanation can be provided for the glossary term 920-2, 920-3, 920-4. The explanations preferably link to a tutorial in the interactive presentation from which the user accessed the glossary or to a tutorial associated with another interactive presentation. In this example, the glossary provides access to three tutorials: a novice level tutorial 920-2 that is two minutes in length, a beginner level tutorial 920-3 that is 58 minutes in length, and an intermediate level tutorial 920-4 that is 1 hour in length. The glossary also provides access to each of the chapters, 920-5 of an advanced explanation, i.e. an entire class, on the topic. To simplify the user process, the explanations levels (tiers) for a particular term can be limited to four. More or less levels could also be used.

A tutorial for one course that provides information about a concept or a term can be reused in another course. FIG. 19D is a flow diagram describing the process for identifying reusable content according to an embodiment of the invention. The reusable content, such as a tutorial, can be referenced in the glossary by associating the tutorial with a concept name (e.g. glossary term) and with a tier number. As shown at 940, using the name and tier information (name/value pair) the tutorial link can be classified. The tutorials referenced in the glossary are classified according to tiers. For example, there is a tier zero link, which provides the shortest explanations or novice-level explanations (or combination thereof).

At 945, the reference to reusable content can be added to a glossary entry and can thus become accessible from any presentation using that glossary that also has access to the reusable content. At development/build time, the builder generates the first portion of the each glossary entry. The builder formats the glossary entries and creates a reference file in htm format (ref.htm). At run-time, a user can access a glossary from a subject electronic presentation. The glossary can be searched, for example, for explanations of a particular term, and explanations associated with the term can be provided from the user's current electronic presentation and from any other electronic presentations linked in the glossary.

If, for example, a user initiates a glossary query, then at 950, the glossary is searched for potential matches. At 955, the potential matches are filtered for the best match for each tier. In particular, not all of the possible tutorials for a given term or concept in the glossary are shown to the user. For example, showing all possible tutorials of a term or concept for each tier in the glossary might overwhelm the user. Therefore, for a given term or concept, if there is more than one course link for a given tier, only one link for that tier is offered to the user. Priority is given first to a tutorial that is offered within the current unit, if none exist, then within the current course, if none exist, then finally within the current curriculum. This is because the further away from the current subject matter the tutorial is located, the more chance it will not relate to the current subject matter being taken by the user.

For example, suppose that at the beginner level, tier one, there are three beginner level tutorial links available. In this situation, priority is given to the best match for the beginner level by filtering the potential matches. In selecting the best match, the discipline(s) associated with the current electronic presentation and each tutorial may be compared to determine whether they are associated with the same discipline or curriculum. Even within a curriculum or discipline, however, several level one explanations might exist. Thus, the process then tries to choose a match within the course, or even within the chapter or unit that is the closest to the user's location in the presentation. If the tutorial is accessed through a file path that has the longest match with the present content file path (e.g. same directory or sub-directory), then the it is considered the closest match. Random selections techniques may also be used to determine the best match, for example with equal file path matches. At 960, the best matches for each tier are advertised from the glossary.

Glossary terms contain a list of references to all possible course content relating to the given term. The list can be defined using any data structure. The data structure could be segmented into multi-tier groups representing some type of content breakdown, such as, difficulty level or content duration. The data structure will also necessarily identify the content for which the link will load and could also include titles and descriptions of the content.

Below is an example of the data structure using custom HTML tags. Each tier is associated with respective <div id>tags.

```
        <div id=’clink’>
          <div id=’T0’>
        <a style=’display:none;’ Ind=’03.02.06.00’ trx=’TRX101’
list=’584547,584598,584660,584714’ scp=’C’ dur=’9 M’ unitTitle=’Local Networks and
LANs’ lessonTitle=’Supplemental links’>ISDN Draft Definition</a>
        <a style=’display:none;’ Ind=’03.06.03.03’ trx=’TRX102’ list=’170297,104636’
scp=’A’ dur=’3 M’ unitTitle=’Transmission Systems’ lessonTitle=’Lesson 3: Network
Access’>ISDN: Draft Definition</a>
        <a style=’display:none;’ Ind=’03.08.10.00’ trx=’TRX100’
list=’584547,584598,584660’ scp=’C’ dur=’7 M’ unitTitle=’Access to WANs’
lessonTitle=’Supplemental links’>ISDN Draft Definition</a>
          </div>
          <div id=’T3’>
        <a style=‘display:none;’ Ind=‘03.07.01.00’ trx=‘TRX121’ list=‘TRX121’ scp=‘A’
dur=“ unitTitle=” lessonTitle=”></a>
          </div>
        </div>
```

The glossary course links provide an automatic approach that is easily implemented and has substantially the same benefits as the prerequisite approach shown in FIG. 19A. The glossary approach allows the course developer or curriculum manager to go through the course and link to the appropriate terms only once. For every learning node (page, lesson, chapter, unit or course) that provides a self-contained description of a concept, the curriculum manager adds an advertisement for that term declaring the depth and/or the duration of the prerequisite material to be Tier0: novice, Tier1: beginner, Tier2: intermediate, or Tier3: advanced. It is common for a given learning node to advertise multiple topics. These advertisements are brought together as hyperlinks (course links) in a central repository, ideally an on-line glossary as shown in FIGS. 19B-C.

It will be apparent to those of ordinary skill in the art that methods involved in computerized learning system can be embodied in a computer program product that includes a computer usable medium. For example, such a computer usable medium can include a readable memory device, such as a hard drive device, a CD-ROM, a DVD-ROM, or a computer diskette, having computer readable program code segments stored thereon. The computer readable medium can also include a communications or transmission medium, such as a bus or a communications link, either optical, wired, or wireless, having program code segments carried thereon as digital or analog data signals.

It will further be apparent to those of ordinary skill in the art that, as used herein, “interactive presentation” and “glossary” can be broadly construed to mean any electronic content with text, audio, animation, video or media thereof directly or indirectly connected or connectable in any known or later-developed manner to a device such as a computer. It will further apparent to those of ordinary skill in the art that, as used herein, “user” can be broadly construed to mean any student, learner or seeker of entertainment.

While this invention has been particularly shown and described with references to particular embodiments, it will be understood by those skilled in the art that various changes in form and details may be made to the embodiments without departing from the scope of the invention encompassed by the appended claims.

1. A computerized system for controlling a development environment using a standard word processing document comprising:
a standard word processing document;
a wizard controlling the standard word processing document; and
an electronic table having at least two states, the electronic table being coupled to the standard word processing document, the state of the electronic table defining an operating mode associated with the wizard.

2. A computerized system as in claim 1 wherein the state of the electronic table is associated with a media development context.

3. A computerized system as in claim 2 wherein the media development context is at least one of: a storyboard, a lesson, a page, an interactive exercise, a pretest question or an assessment question.

4. A computerized system as in claim 3 wherein the electronic table is associated with at least one of: a storyboard table, a media table, an interactive exercise table, a pretest table, or an assessment table.

5. A computerized system as in claim 1 wherein the wizard is in communication with a builder engine, the builder engine being responsible for generating data based on the state of the electronic table.

6. A computerized system as in claim 5 wherein the builder engine being responsible for generating data based on the state of the electronic table further includes the builder generating data that is associated with an electronic presentation.

7. A computerized system as in claim 6 wherein the electronic presentation is related to e-learning.

8. A computerized system as in claim 5 wherein the state of the electronic table is defined based on constructs identified in the electronic table or in a heading that prefaces the table, where the builder is responsive to the constructs.

9. A computerized system as in claim 1 further including:
an object reference associated with the standard word processing document; and
the object reference being used by the wizard to send commands to the standard word processing document.

10. A computerized system as in claim 1 wherein the wizard controls the standard word processing document using object linking and embedding.

11. A computerized system as in claim 1 wherein the modifications are made to the standard word processing document without launching a separate window.

12. A computerized system as in claim 1 wherein the wizard controlling the word processing document further includes the wizard controlling the standard word processing document without changing operating environments.

13. A computerized system as in claim 1 wherein the wizard has at least two operating modes.

14. A computerized system as in claim 1 wherein the state of the electronic table defining an operating mode associated with the wizard further includes the wizard having at least one of the following modes: a storyboard mode, a media page mode, a lesson mode, an interactive exercise mode, or a pretest mode, or an assessment mode.

15. A computerized system as in claim 1 wherein the wizard responding to user interaction by controlling the standard word processing document.

16. A computerized system as in claim 15 wherein the wizard responding to user interaction further includes:
the wizard monitoring user interaction using a timer event;
the timer event causes the wizard to check the standard word processing document.

17. A computerized system as in claim 16 wherein the timer event causes the wizard to check the standard word processing document further includes:
the timer event being fired at every regular intervals; and
the wizard responding to the event by detecting any changes in user interaction with the standard word processing document.

18. A computerized system as in claim 1 further including the wizard assigns an identifier to the electronic table, the identifier corresponding to the state of the electronic table.

19. A computerized system as in claim 17 wherein identifier changes if the state of the electronic table changes.

20. A computerized system as in claim 19 wherein the wizard toggles between operating modes in response to an identifier change.

21. A computerized system as in claim 1 wherein the wizard enables a user to perform at least one of the following: modify rows in the electronic table, insert media into an electronic presentation, insert a file name and path a cell in the electronic table to identify media for an electronic presentation, insert a thumbnail of a media file, import closed-caption script, time-code closed caption script to media, and define hotspots and dropzones for graphics.

22. A computerized system as in claim 1 wherein the electronic table corresponds to at least a portion of an electronic presentation.

23. A computerized system as in claim 1 wherein the wizard controlling the standard word processing document further includes using a form controller to control the standard word processing document.

24. A method for controlling a development environment using a standard word processing document comprising:
using a wizard, controlling a standard word processing document;
determining a state associated with an electronic table in the word processing document; and
defining an operating mode associated with the wizard using the state of the electronic table.

25. A method for controlling a development environment as in claim 24 wherein the electronic table corresponds to at least one of: a storyboard, lesson, page, interactive exercise, pretest question or assessment question.

26. A method for controlling a development environment as in claim 25 wherein the storyboard, the page, the interactive exercise, the pretest question or the assessment question are implemented in at least a portion of an electronic presentation.

27. A system for controlling a development environment using a standard word processing document comprising:
means for controlling, using a wizard, a standard word processing document;
means for determining a state associated with an electronic table in the word processing document; and
means for defining an operating mode associated with the wizard using the state of the electronic table.
